(19) United States
(12) Patent Application Publication
(10) Pub. No.: US 2018/0060872 A1
(43) Pub. Date: Mar. 1, 2018

(54) CUSTOMER SUPPORT SYSTEM AND CUSTOMER SUPPORT METHOD

(71) Applicant: Hitoshi ISHIDA, Tokyo (JP)

(72) Inventor: Hitoshi ISHIDA, Tokyo (JP)

(21) Appl. No.: 15/669,888

(22) Filed: Aug. 4, 2017

(30) Foreign Application Priority Data
Aug. 9, 2016 (JP) 2016-157002

(51) Int. Cl. G06Q 30/00; G06F 11/07

(52) U.S. Cl. CPC G06Q 30/016; G06F 11/0709; G06Q 10/20; G06F 11/079; G06F 11/0778

(57) ABSTRACT

There has not been a service for integrally supporting a customer from a time of purchasing a product through a time of purchasing a next new product, wherein use state information on product users is collected and analyzed with respect to deterioration and abnormality conditions while using the product, product resale time and time of purchasing a new product.

This invention provides a customer support system for integrally supporting a customer, aiming to maximize benefits of the customer at the time of using the product, mending/repairing and reselling/selling the product after having used the product, and purchasing a next new product.

### REFERENCE TO RELATED APPLICATION

This is a continuation allocation which claims priority from a Japanese patent application No. 2016-157002, filed on Aug. 9, 2016, the entire content of which is incorporated herein by reference.

### TECHNICAL FIELD

This invention pertains to a customer support system for achieving integrated support, which displays, to a customer who purchases and uses a product (can be goods), use state/situation support information, deterioration/abnormality analysis support information, mending/repair support information, resale support information, buying company information, economy/environment/safety information, and new device purchase support information of the product and other products compared with said product, and

aims to maximize benefits of the customer when using, mending/repairing the product, reselling/selling the product after having used, and purchasing a next new product.

There has not been a service pertaining to a customer support system for integrally supporting a customer who purchases and uses a product, which displays, to the customer, use state/situation support information,

deterioration/abnormality analysis support information, mending/repair support information, resale support information, buying company information,

economy/environment/safety information and new device purchase support information on the product and other products compared with the product, and

maximizes benefits of the customer when mending/repairing the product and reselling/selling the product after having used, and purchasing a next new product.

### PRIOR ART DOCUMENT

### Document

Document 1: JP 2014-071791

### SUMMARY OF THE INVENTION

Main needs that a customer faces after having purchased a product could be organized as follows:

(1) to display, as customer support information, the past, present or future (predicted) use state information, use situation information and user habit information on the product and other products compared with the product;

(2) to display, on the basis of each piece of information mentioned in section (1) above, the past, present and future (predicted) use deterioration and natural deterioration, cause or factor of the use deterioration and natural deterioration, necessity of mending/repairing the use deterioration and natural deterioration, method for mending/repairing the use deterioration and natural deterioration, prediction of mending/repair cost for the use deterioration and natural deterioration, the most appropriate time for mending/repairing the use deterioration and natural deterioration, the most appropriate mending/repairing company for the use

deterioration and natural deterioration, and the past, present and future (predicted) abnormality of the product and other products compared with the product, and to display, as customer support information, information such as cause or factor of an abnormality, necessity of mending/repairing the abnormality, prediction of mending/repair cost for the abnormality, the most appropriate time for mending/repairing the abnormality and the most appropriate mending/repairing company for the abnormality;

(3) to display, as customer support information on the basis of at least one piece of information mentioned in sections (1) and (2) above, information such as the past, present and future resale price prediction information, asset value information based on the resale price prediction information, the most appropriate resale time (reselling time), and the most appropriate buying company of the product and other products compared with the product;

(4) to display, as customer support information on the basis of at least one piece of information mentioned in sections (1)-(3) above, the present, past and future information pertaining to economy, environment and safety of the product and other products compared with the product; and

(5) to display, as customer support information on the basis of at least one piece of information mentioned in sections (1)-(4) above, information such as the most appropriate new product information, the most appropriate replacement time, the most appropriate dealer information and the most appropriate finance trader information on the product and other products compared with the product.

In a current situation where there is no service capable of integrally providing the customer needs (1) to (5) above, a customer who purchased a product (goods) has problems such as those below.

(1) It has been impossible for a customer who uses a product to figure out and judge each piece of information pertaining to use state, use situation and user habit of the product that the customer uses and other products that the customer desires to compare with the product, and analysis information thereon, because there is no service mentioned in section (1) of the preceding paragraph [0004] of the present patent specification, so that it has been impossible to objectively acquire, display and compare said information, as needed.

Consequently, it has been difficult for a customer who uses a product to correct, improve and advance his/her usage for the product, for example.

(2) It has been impossible for a customer who uses a product to acquire, display and compare, as needed, information pertaining to deterioration and abnormality of the product that the customer uses and other products that the customer desires to compare with the product, and mending/repair methods or mending/repairing company information because there is no service mentioned in section (2) of the preceding paragraph

of the present patent specification. Accordingly, a customer who uses a product has the following problems:

a) it has been impossible to objectively acquire, display and compare, as needed, use state information, use situation information and user habit information on an individual product, and information pertaining to deterioration and abnormality of the product and other products compared with the product, based on analysis information thereon, so that it has been difficult to know in detail the cause and factor the deterioration and abnormality, for example, and it has be impossible to objectively compare deterioration and abnormality events of an individual customer's product with deterioration and abnormality events of other products compared with the product;

b) if it is possible to display and know, as needed, information pertaining to deterioration and abnormality of other products compared with a product that a customer uses, and cause and factor leading to the deterioration and abnormality before the product that the customer uses reaches the deterioration or abnormality, for example, it is possible to overcome the problem of preventing the product that the customer uses from reaching the deterioration and abnormality, but it is in a situation where it is impossible;

c) if it is possible to acquire, display and compare, as needed, information pertaining to deterioration and abnormality, information predicting cause and factor leading to the deterioration and abnormality, mending/repairing company information and the like on a product that a customer uses and other products that the customer desires to compare with the product, for example, it is possible to correspond to interruption and cancellation of work, action, plan and the like that occur at the time of generation of sudden deterioration and abnormality of a product, quick acquisition of a proper mending/repair method, quick acquisition of proper mending/repairing company information,

proper mending/repair cost prediction, and the like, but it is in a situation where it is impossible;

d) it has also been difficult for a customer to compare and determine, when a deterioration or abnormality occurs on a product that the customer uses, for example, whether the deterioration or abnormality is temporary and can be automatically recovered, can be mended/repaired by the customer, or needs mending/repair request to a mending/repairing company; and

e) it has also been difficult to predict a resale price based on a deterioration or abnormality history and a mending/repair history of the product, for example, and accordingly, it has been impossible to properly determine an asset value and an insurance evaluation.

(3) It has been impossible for a customer who uses a product to acquire, display and compare, as needed, information pertaining to resale of the product that the customer uses and other products that the customer desires to compare with the product, and buying company information because there is no service mentioned in section (3) of the preceding paragraph

of the present patent specification, so that a customer who uses a product has the following problems:

a) it has been possible to acquire, through resale price evaluation methods currently provided on the Internet, for example, only very common resale price prediction based on usage time, time of possession, energy efficiency deterioration, moving distance and the like pertaining to a product, i.e., said prediction has not been a resale price prediction based on detailed information such as use state information, use situation information, user habit information, deterioration/abnormality support information and mending/repairing company information, and history and analysis information thereon on an individual product, so that it has been difficult to predict a proper resale price (asset value prediction) and it has been necessary to go to a buying company or the like for survey and interview with spending a long time, when the customer desires to acquire a proper resale price prediction;

b) in addition, even when a resale price prediction of a product could have been acquired by any method,

the properness of the acquired resale price prediction could not have been determined on the basis of objective materials if an individual customer could not acquire, display and compare resale price prediction of the product that the customer uses and other products compared with the product;

c) it has been difficult until now to acquire a proper resale price prediction (asset value prediction), as mentioned above, so that it has been impossible to appropriately evaluate and assess an asset value, and finance on the basis of a resale price of a product, for example;

d) in addition, there has been no service for providing future resale price prediction information based on current resale price information, so that it has been difficult to predict the most appropriate resale time and make a plan at the time of purchasing a new product, for example;

e) furthermore, when searching a buying company at the time of resale, it has been necessary to search on the Internet or go to several companies for consultation, so that time and labor have been necessary; and

f) moreover, it has been difficult to evaluate economy, environment and safety of a product, which is based on the resale price prediction information and buying company information.

(4) It has been impossible for a customer who uses a product to acquire, display and compare, as needed, information pertaining to economy, environment and safety of the product that the customer uses and other products that the customer desires to compare with the product, in the present, past or future because there is no service mentioned in section (4) of the preceding paragraph [0004] of the present patent specification, so that a customer who uses a product has the following problems:

a) it has been impossible to acquire, display and compare detailed information such as use state information, use situation information, user habit information, deterioration/abnormality support information, mending/repairing company information, resale price prediction information, buying company information and the like on an individual product, and

information pertaining to economy, environment and safety, which is based on the history and analysis of said information, so that it has been impossible for a customer who uses the product to acquire detailed information pertaining to economy, environment and safety, and determine such information as more reliable information;

b) it has been impossible to acquire, display and compare information on economy, environment and safety of a product that an individual customer uses and other products compared with the product, and analysis information thereon, and it has been difficult to objectively determine economy, environment, safety, performance, efficiency, effect and the like of a product that an individual customer uses, so that it has been difficult for an individual customer himself/herself to objectively determine a product as a whole, and accordingly, it has been difficult for the individual customer himself/herself to study and execute correction, improvement and advancement of his/her usage for a product that the individual customer uses on the basis of the customer's own determination pertaining to economy, environment, safety, performance, efficiency, effect and the like of the product that the customer uses; and

c) in addition, it has also been difficult for a customer who uses a product to acquire and display an average value or analysis evaluation information on economy, environment and safety of a product that the customer uses and other products that the customer desires to compare with the product, thereby enabling provision of advices on product usage for the individual customer.

(5) It has been impossible for a customer who uses a product to acquire, display and compare, as needed, the most appropriate new product information, the most appropriate replacement time, the most appropriate dealer information, the most appropriate finance trader information and the like on the product that the customer uses and other products that the customer desires to compare with the product because there is no service mentioned in section (5) of the preceding paragraph [0004] of the present patent specification, so that a customer who uses a product has the following problems:

a) it has been impossible to acquire, display and compare detailed information such as use state information, use situation information, user habit information, deterioration/abnormality support information, mending/repairing company information, resale price prediction information, buying company information, economy/environment/safety information on an individual product, for example, and the most appropriate new product information, the most appropriate replacement time, the most appropriate dealer information and the most appropriate finance trader information, and the history and analysis information thereon, which are based on the history and analysis information on the information, so that it has been impossible to acquire various kinds of information and individual promotion information conforming to marketing for an individual customer who uses a product, and customer benefit has not been obtained;

b) in other words, it has been impossible to simply and comprehensively acquire data of previous deterioration and abnormality of a product, and data for objectively understanding the most appropriate resale price information, finance information related thereto, customer' habit related to product use and the like, so that it has been difficult to purchase a new product that fulfills various personal needs, wherein past product use information is made use of at the time of replacement to a new product, and it has been impossible to make a plan for replacement when the resale price did not decrease too much, or when loss in operation energy cost loss does not make progress because product deterioration advances too much, thereby creating customer benefit; and

c) time and labor have been necessary also when searching the most appropriate company that sells a product to be purchased next.

### MEANS FOR SOLVING PROBLEMS

A customer support system according to the first invention of the present application is provided with multiple first devices and one or more second devices that are connected to the multiple first devices via a first network, wherein each of the multiple first devices is provided with a use state/situation support information display unit which displays, as use state/situation support information, the past, present and future use state information, use situation information and user habit information on each of the multiple first devices, and a device information display unit which displays, as device information, information representing each of the multiple first devices in order for each of the multiple first devices to transmit/receive information with the one or more second devices via the first network using transmission/reception units described below, and the multiple first devices and the one or more second devices are provided with transmission/reception units which mutually transmit/receive the use state/situation support information that each of the multiple first devices displays, via the first network using the device information.

A customer support system according to the second invention of the present application is provided with multiple first devices and one or more second devices that are connected to the multiple first devices via a first network, wherein each of the multiple first devices is provided with a use state/situation support information display unit which displays, as use state/situation support information, the past, present and future use state information, use situation information and user habit information on each of the multiple first devices,

a deterioration/abnormality analysis support information display unit which displays, as deterioration/abnormality analysis support information, information pertaining to the past, present and future deterioration and abnormality of each of the multiple first devices, on the basis of the use state/situation support information,

a mending/repair support information display unit which displays, as mending/repair support information, at least one of mending/repair methods and mending/repair companies for each of the multiple first devices on the basis of the deterioration/abnormality analysis support information, and a device information display unit which displays, as device information, information representing each of the multiple first devices in order for each of the multiple first devices to transmit/receive information with the one or more second devices via the first network using transmission/reception units described below, and

the multiple first devices and the one or more second devices are provided with transmission/reception units which mutually transmit/receive the use state/situation support information, the deterioration/abnormality analysis support information and the mending/repair support information that each of the multiple first devices displays, via the first network using the device information.

A customer support system according to the third invention of the present application is provided with multiple first devices and one or more second devices that are connected to the multiple first devices via a first network, wherein each of the multiple first devices is provided with a use state/situation support information display unit which displays, as use state/situation support information, the past, present and future use state information, use situation information and user habit information on each of the multiple first devices,

a deterioration/abnormality analysis support information display unit which displays, as deterioration/abnormality analysis support information, information pertaining to the past, present and future deterioration and abnormality of each of the multiple first devices, on the basis of the use state/situation support information,

a mending/repair support information display unit which displays, as mending/repair support information, mending/repair methods and mending/repair companies for each of the multiple first devices on the basis of the deterioration/abnormality analysis support information, a resale support information display unit which displays, as resale support information, information pertaining to the past, present and future resale of each of the multiple first devices, on the basis of at least one piece of the use state/situation support information, the deterioration/abnormality analysis support information and the mending/repair support information,

a buying company information display unit which displays, as buying company information, information on buying companies for each of the multiple first devices, on the basis of the resale support information, and a device information display unit which displays, as device information, information representing each of the multiple first devices in order for each of the multiple first devices to transmit/receive information with the one or more second devices via the first network using transmission/reception units described below, and wherein the multiple first devices and the one or more second devices are provided with transmission/reception units which mutually transmit/receive the use state/situation support information, the deterioration/abnormality analysis support information, the mending/repair support information, the resale support information and the buying company information that each of the multiple first devices displays, via the first network using the device information.

Each of the multiple first devices is preferably further provided with an economy/environment/safety support information display unit which displays, as economy/environment/safety support information, at least one piece of economy information, environment information and safety information on each of the multiple first devices on the basis of at least of the use state/situation support information, the deterioration/abnormality analysis support information, the mending/repair support information, the resale support information and the buying company information, wherein the transmission/reception units in the multiple first devices and the one or more second devices further mutually transmit/receive the economy/environment/safety support information on each of the multiple first devices via the first network.

A customer support system according to the fourth invention of the present application is provided with multiple first devices and one or more second devices that are connected to the multiple first devices via a first network, wherein each of the multiple first devices is provided with a use state/situation support information display unit which displays, as use state/situation support information, the past, present and future use state information, use situation information and user habit information on each of the multiple first devices, a deterioration/abnormality analysis support information display unit which displays, as deterioration/abnormality analysis support information, information pertaining to the past, present and future deterioration and abnormality of each of the multiple first devices, on the basis of the use state/situation support information,

a mending/repair support information display unit which displays, as mending/repair support information, mending/repair methods and mending/repair companies for each of the multiple first devices on the basis of the deterioration/abnormality analysis support information,

a resale support information display unit which displays, as resale support information, information pertaining to the past, present and future resale of each of the multiple first devices, on the basis of at least one piece of the use state/situation support information, the deterioration/abnormality analysis support information and the mending/repair support information, a buying company information display unit which displays, as buying company information, information on buying companies for each of the multiple first devices, on the basis of the resale support information, an economy/environment/safety support information display unit which displays, as economy/environment/safety support information, the past, present and future economy information, environment information or safety information on each of the multiple first devices, on the basis of at least of the use state/situation support information, the deterioration/abnormality analysis support information, the mending/repair support information, the resale support information and the buying company information,

a new device purchase support information display unit which displays, as new device purchase support information, at least one piece of support information pertaining to purchase of new device and finance trader information at the time of purchasing a new device, on the basis of at least one piece of the use state/situation support information, the deterioration/abnormality analysis support information, the mending/repair support information, the resale support information, the buying company information and the economy/environment/safety support information, and

a device information display unit which displays, as device information, information representing each of the multiple first devices in order for each of the multiple first devices to transmit/receive information with the one or more second devices via the first network using transmission/reception units described below, and wherein the multiple first devices and the one or more second devices are provided with transmission/reception units which mutually transmit/receive the use state/situation support information, the deterioration/abnormality analysis support information, the mending/repair support information, the resale support information, the buying company information, the economy/environment/safety support information and the new device purchase support information that each of the multiple first devices displays, via the first network using the device information.

Any one of the multiple first devices and the one or more second devices is preferably further provided with a storage unit which stores at least one piece of information that each unit in each of the multiple first devices displays, and information that is transmitted/received by the transmission/reception units, and an information analysis information display unit which executes at least one of collection, analysis and calculation of each piece of information stored in the storage unit, as information analysis information, the one or more second devices storing, in the storage unit in the second device, at least one piece of use state/situation support information, deterioration/abnormality analysis support information, mending/repair support information, resale support information, buying company information,

economy/environment/safety support information and new device purchase support information on multiple third devices compared with the multiple first devices; a third device information display unit which acquires, from the one or more second devices via the network using the transmission/reception units in the multiple first devices, and displays at least one piece of use state/situation support information,

deterioration/abnormality analysis support information, mending/repair support information, resale support information, buying company information,

economy/environment/safety support information and new device purchase support information on multiple third devices compared with the multiple first devices, in each of the multiple first devices; a display unit which displays at least one piece of information among information displayed on each unit in each of the multiple first devices; a control unit which controls at least one of the units in each of the multiple first devices; a location information display unit which displays at least one piece of location information on the multiple first devices and the multiple third devices compared with the multiple first devices; and second transmission/reception units which mutually transmit/receive, among the multiple first devices via a second network, each piece of information displayed on the units in each of the multiple first devices, and wherein the transmission/reception units in the multiple first devices and the one or more second devices further mutually transmit/receive at least one piece of the location information on the multiple first devices or the multiple third devices compared with the multiple first devices and the information analysis information.

It is preferable that, when the multiple first devices are vehicles, the economy/environment/safety support information display unit is further provided with a drive start time detection unit which detects a vehicle drive start time (time of driving an engine or motor) of the vehicle, a drive stop time detection unit which detects a vehicle drive stop time of the vehicle, a running distance measurement unit which starts, when the drive start time detection unit has detected the vehicle drive start time, measurement of a vehicle running distance accordingly after the detection, and stops, when the drive stop time detection unit has detected the vehicle drive stop time, the measurement of the vehicle running distance accordingly, then displays the measured vehicle running distance, and a running energy measurement unit which measures a consumption of running energy consumed by the vehicle for funning the vehicle running distance that the running distance measurement unit has measured, wherein the economy/environment/safety support information display unit is further provided with an identification-attached vehicle running information display unit which attaches identification information to at least one of the vehicle drive start time, the vehicle drive stop time, the vehicle running distance and the running energy consumption, associates (links) two or more of said features with one another, to generate identification-attached vehicle running information, and stores the generated identification-attached vehicle running information in at least one storage units in the multiple first devices or the one or more second devices, an average vehicle speed display unit which uses the vehicle drive start time, the vehicle drive stop time and the vehicle running distance, to calculate an average vehicle speed of the vehicle that has run the vehicle running distance, and an energy consumption cost display unit which uses the running energy consumption and the price of the drive energy per unit which has been acquired separately in advance, to calculate a consumption cost of energy that the vehicle has consumed to run the vehicle running distance.

### EFFECT OF THE INVENTION

The present invention provides the following effects to a customer who purchases and uses a product.

(1) The past, present or future use state information, use situation information and user habit information on a product and other products compared with the product are displayed as customer support information. Therefore, it is possible to solve the problem mentioned in section (1) of paragraph [0005] of the present patent specification.

(2) Information pertaining to deterioration and abnormality of a product and one more other products compared with the product, and information on content and cause or factor of a use deterioration, content and cause or factor of a natural deterioration, prediction of the use and natural deteriorations, necessity of mending/repairing the use and natural deteriorations, prediction of mending/repair cost for the use and natural deteriorations, the most appropriate time of mending/repairing the use and natural deteriorations, the most appropriate mending/repairing company for the use and natural deteriorations, content and cause or factor of an abnormality, prediction of the abnormality, necessity of mending/repairing the abnormality, prediction of mending/repair cost for the abnormality, the most appropriate time of mending/repairing the abnormality, the most appropriate mending/repairing company and the like are displayed as customer support information on the basis of at least one piece of information described in section (1) above. Therefore, it is possible to solve the problem mentioned in section (2) of paragraph [0005] of the present patent specification.

(3) Resale price prediction information, asset value prediction information based on the resale price prediction, and information on the most appropriate resale time (selling time) and the most appropriate buying company, and the like on a product and other products compared with the product, are displayed as customer support information on the basis of at least one piece of information described in section (1) or (2) above. Therefore, it is possible to solve the problem mentioned in section (3) of paragraph [0005] of the present patent specification.

(4) Information and the like pertaining to economy, environment and safety of a product and other products compared with the product are displayed as customer support information on the basis of at least one piece of information described in sections (1) to (3) above.

Therefore, it is possible to solve the problem mentioned in section (4) of paragraph [0005] of the present patent specification.

(5) The most appropriate new product information, the most appropriate replacement time, the most appropriate dealer information, the most appropriate finance trader information and the like are displayed as customer support information on the basis of at least one piece of information described in sections (1) to (4) above. Therefore, it is possible to solve the problem mentioned in section (5) of paragraph [0005] of the present patent specification.

The present invention is capable of integrally providing and creating, in one stop manner, the effects mentioned above in the respective sections (1) to (5) of paragraph [0005] of the present patent specification, which serves as a beneficiary for many people related to the services provided by the present invention, such as users (purchasers) of the product, used product purchasing companies of the product, mending/repair companies, new product dealers, finance traders and insurance companies.

### BRIEF DESCRIPTION OF THE DRAWINGS

FIG. 1 is a block diagram representing the entire structure of the present invention.

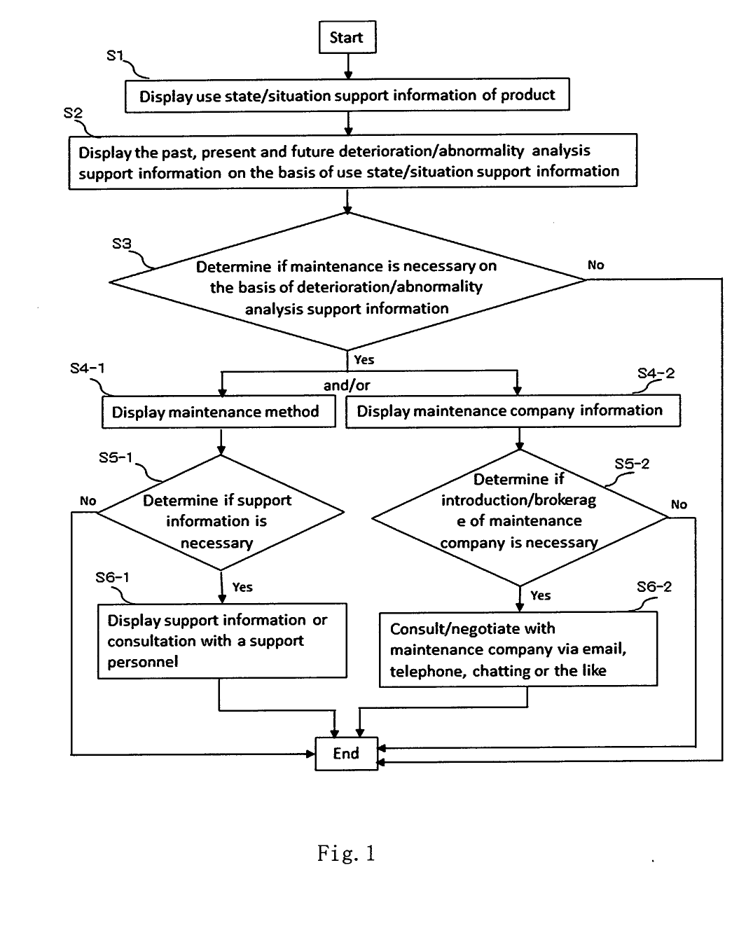

FIG. 2 is a schematic flow diagram representing a display flow in a deterioration/abnormality analysis support information display unit according to the present invention.

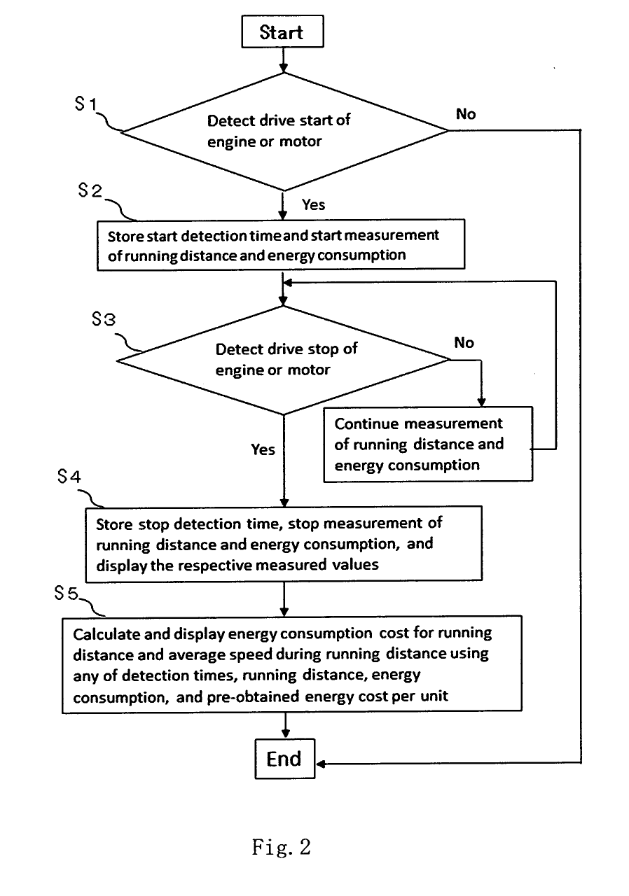

FIG. 3 is a schematic flow diagram representing a display flow in an economy display on an economy/environment/safety support information display unit according to the present invention.

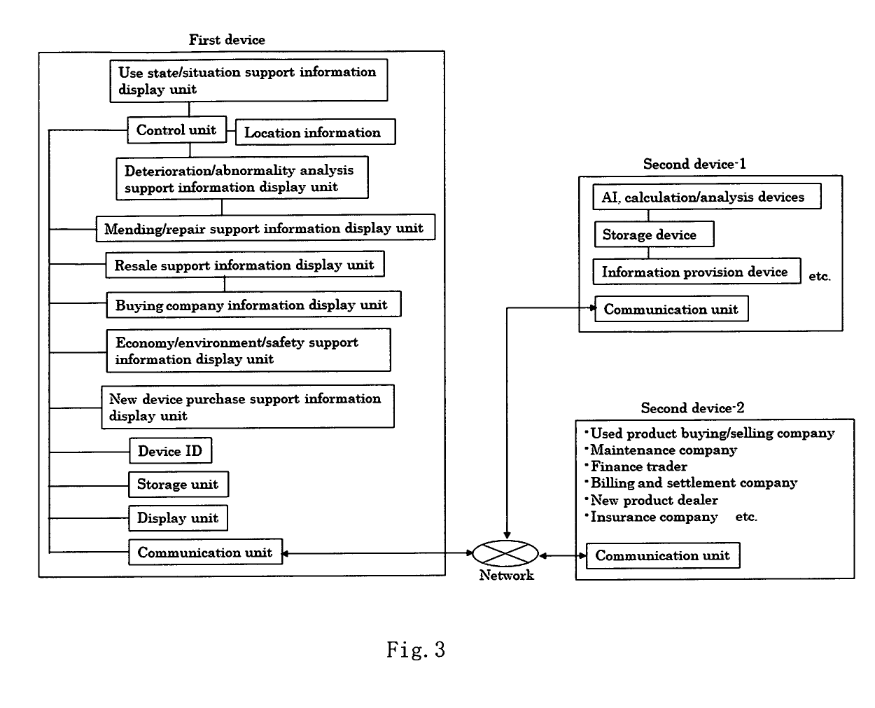

### DESCRIPTION OF THE EMBODIMENTS

The first embodiment of the present invention is a customer support system provided with multiple first devices, and one or more second devices that are connected to the multiple first devices via a first network, wherein each of the multiple first devices is provided with a use state/situation support information display unit which displays, as use state/situation support information, the past, present and future use state information, use situation information and user habit information on each of the multiple first devices, and a device information display unit which displays, as device information, information representing each of the multiple first devices in order for each of the multiple first devices to transmit/receive information with the one or more second devices via the first network using transmission/reception units described below, and the multiple first devices and the one or more second devices are provided with transmission/reception units which mutually transmit/receive the use state/situation support information and the device information that each of the multiple first devices displays, via the first network.

The use state/situation support information display unit acquires, generates and displays use state information, use situation information and user habit information on each of the multiple first devices (goods). The use state information, use situation information and user habit information on each of the multiple first devices (products) mean, for example, use state information, use situation information and user habit information on a product that a customer uses and other products compared with the product. The use state/situation support information display unit is configured with, for example, information acquisition equipment such as various sensors (may be physical sensor, chemical sensor or any other sensors), various diagnostic instruments, various kinds of monitoring and alarm equipment, micro controller, microprocessor and system-on-chip (SoC), and acquires, generates and displays use state information, use situation information and user habit information on each of the multiple first devices. In addition, when a use state/situation support information display unit acquires, generates and displays use state information, use situation information and user habit information on each of the multiple first devices, said information may be acquires from other pieces of information providing devices, information providing companies or the like, for example, or may be information inputted by a user or a third party. There is a case where the inputted information is important for the system of the present invention, and can be known only by a user of the product, such as various kinds of accident information, various kinds of damage information, lost information, various kinds of deterioration factor information and various kinds of abnormality factor information, for example, which would directly or indirectly affect information displayed on the units in deterioration/abnormality analysis support information display unit, mending/repair support information display unit, resale support information display unit, buying company information display unit, economy/environment/safety support information display unit and new device purchase support information display unit, some of which are described later, for example.

(Note that there also is case where various kinds of accident information, various kinds of damage information, lost information, various kinds of deterioration factor information and various kinds of abnormality factor information are detected by the abovementioned sensors and the like) The information acquired in such a manner may be stored in the storage unit in each of the multiple first devices, read out therefrom by a read-out unit, and displayed.

In addition, the configuration of a use state/situation support information display unit is not limited to the abovementioned configuration example, but may be any configuration as far as said configuration can acquire and display use state information, use situation information or user habit information on each of multiple first devices.

Furthermore, the use state information, use situation information or user habit information on each of multiple first devices may be either digital information or analogue information.

The feature wherein “the use state/situation support information display unit acquires, generates and displays the use state information, use situation information and user habit information on each of the multiple first devices” means that the use state/situation support information display unit stores, accumulates, collects, integrates, reshapes, edits, analyses, mines, calculates, evaluates, learns, and the like each piece of the acquired information, for example, to generate and display the result. In addition, in that case, the device that stores, accumulates, collects, integrates, reshapes, edits, analyses, mines, calculates, evaluates, learns and the like each piece of the information may be any device among those in each of multiple first devices and one or more second devices.

A method for acquiring the use state information, use situation information and user habit information may be either wired or wireless. A method for displaying the use state information, use situation information or user habit information may display on a display, display with voice, or store on a storage unit.

A method for displaying the use state information, use situation information and user habit information may display on at least one of multiple first devices and one or more second devices. A storage medium configuring the storage unit is in a format such as magnetic disk format, optical disk format, flash memory format and magneto-optical disk format, for example, but not limited to the examples listed above, and may be in any format. In addition, the storage format may be either digital data or analogue data.

The multiple first devices in the present invention mean products or goods. The products are sometimes classified into service, software, hardware and material product, for example. Hardware is a general term representing a physical configuration element of a system, such as machine, device and facility. Each of the multiple first devices is not limited to machine, device and facility, but may be any device as far as said device can acquire and display, as use state/situation support information, at least one piece of use state information, use situation information and user habit information on the device. Each of the multiple first devices is not limited to service, software and material product, but may be any device as far as said device can acquire and display, as use state/situation support information, at least one piece of use state information, use situation information and user habit information on the device, in a similar manner.

The one or more second devices are classified into the following two devices for the roles thereof:

(1) a device that stores, accumulates, collects, integrates, reshapes, edits, analyses, processes, mines, calculates, evaluates, learns, multiples and compares with other pieces of information, and the like each piece of information that has been transmitted from multiple first devices or originally acquired, for example, and transmits the result to the multiple first devices; and

(2) a device that stores or acquires information necessary for multiple first devices, and transmits/provides the necessary information to the multiple first devices in advance or when the multiple first devices require said information. Note that the one or more second devices are not limited to the examples listed above, but may be any device as far as said device can transmit/receive and provide information necessary for information that each unit provided to the first device displays, with the multiple first devices via a first network.

The multiple first devices and the one or more second devices are provided with transmission/reception units which mutually transmit/receive the use state/situation support information and the device information displayed on each of the multiple first devices via the first network, wherein a predetermined device among the multiple first devices displays and compares, using the use state/situation support information display unit, the use state information, use situation information and user habit information on the predetermined device, and the use state information, use situation information and user habit information on multiple first devices other than the predetermined device.

Note that each of the multiple first drives may transmit/receive, via a first network, and display, using a transmission/reception means, the use state information, use situation information and user habit information with other first devices, which is discussed later.

The multiple first devices are devices (products) among a group of devices each having the same manufacturer, same name, same product number, same type, kind, same category, an equivalent price, an equivalent energy efficiency and the like, for example, as/to those of the first devices, which a customer who uses one of the multiple first devices (products) desires to compare with the device.

In addition, other devices compared with the multiple first devices are not limited to the abovementioned examples, but may be any devices as far as a customer who uses one of the multiple first devises (products) desires to compare said devices with the first device.

The use state information is information (quality and performance information) on a state pertaining to motion, work, action, function, operation, working, calculation, information processing or behavior, for example, of each of the multiple first devices. Specific examples of the use state information include the following information at the time when each of the multiple first drives starts a motion by motive power, usefully works or acts, or prepares to work or act, for example:

(1) state information on motion, work or action;

(2) state information pertaining to efficiency of motion, work or action;

(3) state information pertaining to effect of motion, work or action;

(4) state information pertaining to quality of motion, work or action;

(5) state information pertaining to durability, sustainability, deterioration or abnormality of motion, work or action;

(6) state information pertaining to safety of motion, work or action; and

(7) state information pertaining to control, cooperation or communication of motion, work or action.

Note that the use state information is not limited to the examples listed above, but may be any information as far as said information is state information pertaining to the motion, work, action, function, operation, working, calculation, information processing or behavior of the multiple first devices, and can be acquired and displayed.

In a case of a moving body, for example, the use state information may be information pertaining to moving distance, speed, fuel efficiency, acceleration, driving method, safety, various control system or the like. The use state information may be either analogue information or digital information, and may be any information such as text, image, sound and signal.

In addition, the use state information is expressed here as that “of multiple first devices”, but may contain use state information on a person or robot which operates/steers each of the multiple first devices and use state information on computer and the like which remotely control said devices.

The use state information is configured by information acquisition equipment such as, for example, various sensors (may be physical sensor, chemical sensor or any other sensors), measurement equipment, microcontroller, microprocessor, system-on-chip (SoC), and is generated and displayed (stored) by acquiring use state information on each of the multiple first devices. In addition, each piece of information displayed on the use state/situation support information display unit in the first device may be transmitted to the one or more second devices via a first network, and stored in a storage unit in the second device, as needed. Furthermore, the use state information may be information (text, voice, image, human behavior or the like) inputted by a person. In that case, the inputted information may be stored temporarily or permanently in a storage unit, and read out/displayed by a read-out unit, as appropriate.

The use situation information is information on a situation pertaining to motion, work, action, function, operation, working, calculation, information processing or behavior, or on a situation of stopping the same, for example, of the multiple first devices. A specific example of the use situation information is physical or chemical situation information, for example, when the multiple first devices stop motions or are in motion. In addition, the physical or chemical situation information includes situation information on natural phenomena, disaster and the like. The physical situation information is information on a situation such as, for example, sound, temperature, humidity, light (sunlight and other light), vibration, wave, wind (including sea breeze, mountain wind, etc.), sand, particle, electromagnetic field, wind speed, rain, snow, atmospheric pressure, air flow, hydraulic pressure, water current, time, position, inclination, rotation, ascent, descent, gravity, acceleration and light/darkness.

Note that the use situation information is not limited to the examples listed above, but may be any information as far as said information is information on a situation of each of the multiple first devices stopping a motion, or on a situation thereof in motion, work, action, function, operation, working, calculation, information processing or behavior, and can be acquired and displayed. The various kinds of use situation information can be acquired by combining, as appropriate, various sensors (may be physical sensor, chemical sensor or any other sensors), measurement equipment, microcontrollers, microprocessors and system-on-chip (SoC), for example, as mentioned above. In addition, the use situation information may be information (text, voice, image, human behavior or the like) inputted by a person. In that case, the inputted information may be stored temporarily or permanently in a storage unit, and read out/displayed by a read-out unit, as appropriate.

The user habit information is information on habits of a person who uses each of multiple first devices, with respect to the user's usage. For example, when the multiple first devices are moving bodies, the user habit information is information on driving habits of a person who drives a moving body.

Information on driving habits includes, for example, that on whether the driver steps on the sudden accelerating any time when starting the moving body, steps on the sudden braking any time when stopping the moving body, frequently uses engine brake or does not use at all, always loads heavy luggage, uses highway frequently, changes gears in a method different from those of others, has a moving distance (running distance) per day, week or year, which is different from an average thereof of others, often violates driving rules, always listens to music at high volume while driving, takes a pet on ride, often looks away while driving, eats something while driving, and always takes many people on ride. In addition, when the multiple first devices are refrigerators, for example, the user habit information is information on an average number per day of opens/closes of the door of a refrigerator by a user of the refrigerator, whether the number of opens/closes of the door by the user is high or low, whether the refrigerator is always filled with things or almost empty, whether the time of keeping the door open is longer or shorter than the average time of other people, whether the user takes care of the refrigerator according to the product description, whether the user uses the refrigerator in such a manner as dangerous usages in the product description, the number of moving during using the refrigerator, and the like. The use habit information is not limited to the samples listed above, but may be any information as far as a user state/situation support information display unit can acquire and display said information.

The first network is a communication network, a broadcast network or the like, for example, which is a netlike configuration which keeps connection. The first network may be wired or wireless. Note that the first network is not limited to the examples listed here, but may be any other first network as far as information can be mutually transmitted/received among multiple first devices and one or more second devices via said first network using transmission/reception units to be described later.

The device information display unit displays thereon, as device information, information for displaying multiple first devices, in order for each of the multiple first drives to transmit/receive information with the one or more second devices via the first network, using transmission/reception units to be described later. The device information is unique identifications (ID) which specify multiple first devices or are allocated to the multiple first devices. IP address, uniform resource locator (URL), hardware address and ID allocated to equipment that transmits/receives information via a communication network or broadcast network, in such a manner as communication terminal IDs that mobile terminals and the like have, can be used as the device information.

Note that the device information display unit is not limited to the examples listed above, but may be any device information as far as said information is that for displaying multiple first devices, in order for the multiple first devices to transmit/receive information with the one or more second devices via the first network using transmission/reception units to be described later.

Note that, as is mentioned later, the device information that the device information display unit displays thereon is used also as information representing and specifying each of the multiple first devices, in order for the multiple first devices to mutually transmit/receive various kinds of information.

The transmission/reception units mutually transmit/receive (exchange) information among multiple first devices and one or more second devices via a first network.

The transmission/reception units are configured with the most appropriate protocol and hardware interface, for example, according to the environment of a first network to use. In addition, the transmission/reception units are sometimes configured with radio transmission units, antenna reception units, tuners and the like, for example.

Note that the transmission/reception units are not limited to the examples listed here, but may have any configurations as far as said configurations can mutually transmit/receive information among multiple first devices and one or more second devices via the first network. Note also that the transmission/reception units are sometimes used when the multiple first devices mutually transmit/receive various kinds of information via a second network, as is mentioned later. Note that the first network and the second network are both for exchanging information therethrough, but there are cases wherein the first network and the second network use different communication technologies, interfaces and the like, and wherein said networks use the same communication technology, interface and the like. The first network and the second network in the present invention may use any communication technology regardless of whether the technologies and standards used thereby are different from each other or the same, and the like. Note that the first network and the second network use different communication technologies, communication interfaces and the like, in the claims of the present invention, wherein the communication interface using the second network is assigned to a second transmission/reception unit.

In the first embodiment of the present invention, which is configured in such a manner as described above, a user state/situation support information display unit in each of multiple first devices displays, as use state/situation support information, use state information, use situation information and user habit information on each of the multiple first devices, thereby displaying, as customer support information, the past, present or future use state information, use situation information and user habit information on each of the multiple first devices. Therefore, a predetermined first device that an individual customer uses can display, using a use state/situation support information display unit, use state/situation support information, use state information, use situation information and user habit information on the predetermined first device, and display, using the use state/situation support information display unit, use state information, use situation information and user habit information on other first devices, which enables the customer to compare those pieces of information.

The “past, present or future” use state information, use situation information and user habit information on each of multiple first devices, which a use state/situation support information display unit displays thereon, are explained here. The feature wherein a use state/situation support information display unit acquires, displays or stores use state information, use situation information and user habit information is previously mentioned.

It is possible to acquire, display or store the present (current) use state information, use situation information and user habit information, as needed.

When those pieces of information acquired at the present time are stored along with the acquisition time on a storage unit, it is also possible to refer those pieces of information in the future, as the past use state information, use situation information and user habit information.

In addition, comparison of the past use state information, use situation information and user habit information with those pieces of information at the present time, and collection and analysis in chronological order of transitions of deterioration and other changes, and the like, in multiple first devices or one or more second devices make it possible to predict use state information, use situation information and user habit information at a future time.

Accordingly, it is possible for a customer to correct, improve, advance or the like the customer's usage for a product (each of multiple first devices) in a planned manner, by analyzing, comparing, evaluating, learning and recognizing each piece of the past, present and future use state information, use situation information and user habit information, according to various purposes.

All pieces of the use state information, use situation information and user habit information that the use state/situation support information display unit displays thereon in the present invention serve as base information that is displayed on a deterioration/abnormality analysis support information display unit, a mending/repair support information display unit, resale support information display unit, buying company information display unit, economy/environment/safety support information display unit, and new device purchase support information display unit, which are discussed later.

The second embodiment of the present invention is explained next.

Explanation is omitted here on the multiple first devices, one or more second devices, use state/situation support information, use state/situation support information display unit, device information, device information display unit, first network and transmission/reception unit which are explained in the first embodiment of the present invention.

A deterioration/abnormality analysis support information display unit displays, as deterioration/abnormality analysis support information, information pertaining to deterioration and abnormality of each of multiple first devices on the basis of use state/situation support information.

The information pertaining to deterioration and abnormality of each of multiple first devices (products) is, for example, information on content and cause or factor of a use deterioration, content and cause or factor of a natural deterioration, prediction of the use and natural deteriorations, necessity of mending/repairing the use and natural deteriorations, prediction of a mending/repair cost for the use and natural deteriorations, the most appropriate time of mending/repairing the use and natural deteriorations, the most appropriate mending/repairing company for the use and natural deteriorations, content and cause or factor of an abnormality, prediction of the abnormality, necessity of mending/repairing the abnormality, prediction of a mending/repair cost for the abnormality, the most appropriate time of mending/repairing the abnormality, the most appropriate mending/repairing company and the like of the product that the customer uses and other products compared with the product.

The feature wherein “a deterioration/abnormality analysis support information display unit displays, as deterioration/abnormality analysis support information, information pertaining to deterioration and abnormality of each of multiple first devices on the basis of use state/situation support information” means that the deterioration/abnormality analysis support information display unit stores, accumulates, collects, integrates, reshapes, edits, analyses, mines, calculates, evaluates, learns, or multiplies with other pieces of information, and the like each piece of the acquired information, for example, to generate and display the result. In addition, in that case, the device that stores, accumulates, collects, integrates, reshapes, edits, analyses, mines, calculates, evaluates, learns, or multiplies with other pieces of information, and the like each piece of the information may be any device among those in each of multiple first devices and one or more second devices.

A deterioration/abnormality analysis support information display unit generates and displays, as deterioration/abnormality analysis support information, information pertaining to the past, present and future deterioration and abnormality of each on multiple first devices on the basis of the user state/situation support information, in such a manner as described above. A method for displaying each piece of information on the deterioration/abnormality analysis support information display unit may be displaying on a display, displaying with voice, or storing on a storage unit.

The deterioration/abnormality analysis support information generated and displayed by the deterioration/abnormality analysis support information display unit is information pertaining to deterioration and abnormality capable to occur on the basis of the contents of the use state/situation support information, i.e., the contents mentioned in the sections of paragraphs [0016] to [0026] of the present patent specification.

Note that the deterioration/abnormality analysis support information display unit may select information necessary for generating deterioration/abnormality analysis support information among the contents mentioned in the sections of paragraphs [0016] to [0026] of the present patent specification, to generate and display the information on the basis of the selected information.

A method with which a deterioration/abnormality analysis support information display unit in multiple first devices displays deterioration/abnormality analysis support information on each of the multiple first devices on the basis of use state/situation support information, includes at least one of displaying by acquiring and generating use state/situation support information in each of the multiple first devices, displaying by acquiring and generating use state/situation support information in one or more second devices and providing the information to multiple first devices via a first network, and displaying information inputted to the multiple first devices.

Here, deterioration may be defined as a phenomenon in which a performance relatively decreases because the quality, performance and the like of a product or the like are impaired, compared with the previous state, or because excellent products appear through technical innovation.

In other words, the deterioration information mentioned here may be defined as information on a variation or difference between information before deterioration and information after deterioration, or information for recognizing the variation or difference. Information pertaining to deterioration of each of multiple first devices may be defined as information on use deterioration caused by being used by a user of each of the multiple first devices, or information on natural deterioration (deterioration over time) caused by time elapsed and natural environment, for example.

The use deterioration may be defined so as to be possible to occur mainly on the basis of the contents explained above on the use state information and user habit information. However, it is not excluded that said use deterioration occurs on the basis of use situation information. The feature of displaying the past, present and future use deteriorations is explained here. With respect to use deterioration to occur in a first device, there are cases where the same or the same kind of use deteriorations occurs in chronological order, and also where individual use deterioration occurs just once.

When the use deterioration that occurs just once occurred in the past, use deterioration information thereon has been stored in a storage media along with the time of the second device, for example, and is read out and displayed today as the past use deterioration information. When the use deterioration that occurs just one occurred today, use deterioration information thereon is displayed and stored as the present use deterioration information, and will be displayed tomorrow as the past use deterioration information. Information pertaining to the present use deterioration when the same or the same kind of use deteriorations occurs in chronological order may be information on variation or difference between the use deterioration state at any day (past day) from the day at which a customer has acquired a first device to today, and the present (current) use deterioration state, for example.

In other words, the present use deterioration information pertaining to energy efficiency (energy efficiency of motion, work or action) of a first device, for example, may be obtained by storing, along with the time, information pertaining to energy efficiency at any past day from the day of acquisition of the first device to the present, and calculating (such as subtracting a value of worse energy efficiency from a value of better energy efficiency), analyzing, evaluating and displaying the variation or difference thereof with the current energy efficient of the first device.

In addition, when the present (current) use deterioration information is stored along with time, it is also possible to display, as the past use deterioration information, the stored use deterioration information at a time tomorrow or later when the present became the past, thereby confirming and evaluating the past use deterioration information and the current use deterioration information.

When the current use deterioration information on each of multiple first devices having different purchase times or use periods is stored along with the times of occurrences thereof in a storage unit in one or more second devices, for example, in the present invention, a first device which is now purchased can refer to many pieces of use deterioration information for many purchasers of the first devices which have been purchased in the past, and information which is obtained by analysis and analysis of the many previous first devices by one or more second devices, for example.

The information pertaining to the future (predicted) use deterioration can be predicted on the basis of information pertaining to the past and present use deteriorations, for example. In other words, when obtaining the present deterioration difference pertaining to the energy efficiency of the aforementioned first device, for example, the deterioration difference is obtained by comparing the time-attached past energy efficiency with the current energy efficiency, wherein it is also possible to calculate, analyze and predict a future deterioration (deterioration after a predetermined future time has passed) by analyzing a time during which the obtained deterioration difference has been generated. When past deterioration progressions are recoded at as many times as possible, it is possible to determine how the use deterioration progresses in relation to elapsed time, such as proportionally, logarithmically and exponentially, for example. In addition, when information pertaining to the present use deterioration, or use deterioration state or the progress situation information thereon of other multiple first devices having different purchase times and use periods, for example, is collected and analyzed, it is possible to predict a future use deterioration of a predetermined first device, and provide an advice for preventing a use deterioration that is likely to occur from now on.

Note that the information pertaining to the future deterioration is not limited to the examples listed here, but may be any other information as far as a future deterioration can be predicted by said information, mainly on the basis of the use situation information or the present deterioration information on the first device.

The feature of displaying the past, present and future natural deterioration is explained next.

The natural deterioration may be understood as to be lead mainly on the basis of the use situation information.

With respect to natural deterioration to occur in a first device, there are cases where the same or the same kind of natural deteriorations occurs in chronological order, and also where individual natural deterioration occurs just once.

When the natural deterioration that occurs just once occurred in the past, natural deterioration information thereon has been stored along with the time of the second device, and is read out and displayed today as the past natural deterioration information. When the natural deterioration that occurs just one occurred today, natural deterioration information thereon is displayed and stored as the present natural deterioration information, and will be displayed tomorrow as the past natural deterioration information. Information pertaining to the present natural deterioration when the same or the same kind of natural deteriorations occurs in chronological order may be understood as to be led mainly on the basis of the use situation information. Information pertaining to the present natural deterioration is information on variation or difference between the natural deterioration state at any day (past day) from the day at which a customer has acquired a first device to today, and the today's natural deterioration state, for example. The present natural deterioration of a first device, which is caused by time elapsed, may be obtained by displaying the same on the basis of a time elapsed (years, months, days, hours) from the day at which a customer has acquired the first device or a predetermined past day to today, for example.

In other words, it is possible to express the current value of a product having naturally degraded on the basis of a relationship between days of time elapsed of the product and a predetermined depreciation value, for example, and it is also possible to analyze, calculate and express today's value deterioration of a product on the basis of time elapsed of the product until today, by determining in advance a time elapsed at which the value of the product becomes zero.

In addition, the past natural deterioration may be displayed in a similar manner as the method for displaying the past use deterioration, which is described in paragraph [0041] (from “in addition, when the present (current) use deterioration information is” through “by one or more second devices, for example”) of the present patent specification, for example.

In addition, the future (predicted) natural deterioration may be displayed by the same method as that explained in paragraph [0042] of the present patent specification for predicting future use deterioration. A natural deterioration at a predetermined day in the future can be predicted by displaying and analyzing, in chronological order, the past natural deterioration information on other multiple first devices and today' natural deterioration information on a predetermined first device. In addition, also with respect to information pertaining to future natural deterioration, when many pieces of information on time elapsed and natural deterioration are collected and analyzed, it is possible to determine how the natural deterioration progresses in relation to elapsed time, such as proportionally, logarithmically and exponentially, for example. Note that the information pertaining to the present deterioration is not limited to the deviation and difference information listed here, but may be any other deterioration information as far as the past, present and future natural deterioration differences of information pertaining to natural deterioration of the first device can be predicted by said deterioration information, which is led mainly on the basis of the use situation information.

Examples for displaying the past, present and future deteriorations (use deterioration and natural deterioration) of multiple first devices have been explained up to this point. The feature of displaying the causes and factors of deteriorations of multiple first devices (a product and other products compared with the product) is explained next.

The number of times of use, use frequency, use period, use speed and the like of a first device (product) or a specific function, specific part, specific service or the like of the first product may capture attentions as elements getting involved in factors and causes of use deterioration. It is possible to acquire detailed data on the number of times of use, use frequency, use period, use speed and the like which serve as factors or causes of use deterioration, such as many/less, high/low and long/short, by means of various sensors, various kinds of measurement equipment and diagnostic equipment and the like, for example, which are mounted to the multiple first devices, or input by a user, using the use state/situation support information display unit, and collate the same with content of actually occurring use deterioration, thereby displaying the acquired features with the content. Use deterioration and one or more factors or causes thereof may be accurately specified and displayed by collecting many pieces of use deterioration information on multiple first devices and multiple third devices compared with the first devices, and information on factors and causes thereof, storing the information in a storage unit in the one or more second devices, for example, and reading out thereafter the information by a read-out unit, as appropriate, to analyze/lean/improve and the like (using big data analysis method in which artificial intelligence (AI) is made full use of) the information.

In addition, threshold values of factors and causes of use deterioration of a first device (product) or a specific function, specific part, specific service or the like of the first product, for example, which are considered to degrade by use, may be displayed in advance, wherein there may be a case where the first product or the like degrades due to too large number of times of use, and a case where the first product or the like degrades due to too small number of times of use. In each of those cases, when the threshold values are stored in a storage unit, it is possible, using a deterioration/abnormality any support information display unit, to detect/specify factors and causes of use deterioration, and also display the use deterioration predictively before the use deterioration occurs by detecting that a value has been approaching to a threshold value.

It is also possible to display factors and causes of use deterioration predictively in a similar method to the big data analysis method mentioned above, by executing factor and cause analysis of use deterioration of each of multiple first devices and multiple third devices compare with the first devices, using the information pertaining to threshold. In addition, the factors and causes of use deterioration are handling method (including accident cause by rough handling and sudden unexpected accident) and the like of a customer of a first device (product), but is not limited to the examples listed here, and may be any factors and causes as far as the use state/situation support information display unit can acquire and display said factors and causes. Here, the multiple third devices are those compared with multiple first devices, in terms of performance, quality, price, service content and the like, for example, as mentioned above. When the multiple first devices are products/goods of the same kind of manufacture and the same type, for example, the multiple third devices may be products/goods of the same kind of manufacture having the same performance, quality, price range and the like, for example, said products/goods having similarities with the first devices. Note that, various kinds of information pertaining to the multiple third devices may be kept in a state where the one or more second devices can acquire in advance, store in a storage unit, and provide said various kinds of information, as appropriate, to the multiple first device, by a similar method or system to that by which the multiple first devices acquire (by transmission/reception) various kinds of information on the multiple first devices.

Next, the specific examples mentioned in paragraph [0024] of the present patent specification, for example, many capture attentions as elements pertaining to factors and causes of natural deterioration. According to paragraph [0024], sound, temperature, humidity, light (sunlight and other light), vibration, wave, wind (including sea breeze, mountain wind, etc.), sand, particle, electromagnetic field, wind speed, rain, snow, atmospheric pressure, airflow, hydraulic pressure, water current, time, position, inclination, rotation, ascent, descent, gravity, acceleration and light/darkness, for example, are listed as the factors or causes of natural deterioration. When a product gathers rust due to sea breeze (sea wind), for example, it is also possible to display rust generation and a cause thereof by mounting, to the first devices, sensors capable of measuring the concentration of salt in air, which is contained in the sea breeze and could be a cause of rust generation, as a method for displaying contents, causes or factors of natural deterioration. In addition, it is possible, by this method, to foresee the natural deterioration of rust generation in advance, and display change to hot-dip galvanized zinc specification or to a stainless material, and the like, for example, as a necessary protection method. When sensor detection data of natural deteriorations of color and the like due to sunlight, wind and the like is stored along with time, using light sensors and wind sensors, for example, and when photo image data is stored by a camera and compared with the past and present photo images, it is possible to display factors and causes of natural deterioration and also the progress thereof. In addition, with respect to a natural deterioration which it is difficult for sensors and the like to detect, when the content of the natural deterioration and information considered to be the cause thereof, for example, are inputted by users of multiple first devices and users of multiple third devices compared with the first devices, stored in a storage unit in one or more second devices, for example, and collected to compile a database, it is also possible to display, to uses of other first devices, the content of natural deterioration and causes thereof by the big data analysis method. Note that the information in the methods for acquiring, displaying, foreseeing and the like factors or causes of natural deteriorations and natural deterioration information thereon are not limited to the examples listed here, but may be any other information pertaining to causes and factors of natural deterioration as far as said information on a situation in which multiple first devices stop motions or information on a situation in which said devices are in motion, work, action, function, operation, working, calculation, information processing or behavior, and the use state/situation support information display unit can acquire and display said information.

The feature of displaying the “necessity of mending/repairing the use deterioration and natural deterioration and method for mending/repairing the use deterioration and natural deterioration of multiple first devices (products) ” is explained next.

First, the feature of displaying the necessity of mending/repairing the use deterioration and natural deterioration of a product and other devices compared with the product is explained. The method for displaying the past, present and future use deterioration information and natural deterioration information, and the method for acquiring/displaying factors and causes of said deteriorations have been explained up to this point.

Information on use and natural deteriorations occurred on the multiple first devices (products) is exchanged between the multiple first devices and one or more second devices via a first network. Accordingly, a large amount of use deterioration information and natural deterioration information on multiple first devices and multiple third devices compared with the first devices are accumulated in storage units in the second devices or the first devices, and it is possible to collect and analyze a large amount of information on circumstance and history in which the use deterioration and natural deterioration states have reached mending/repair, and on circumstance, history and the like in which said deterioration states have reached an abnormality, in such a manner as the abovementioned big data analysis method. When making use of big data analysis of the information on history and the like, it is possible to display (advise), as more accurate information, necessity of mending/repairing use deterioration or natural deterioration of multiple first devices which are currently being used and are in a state of use deterioration or natural deterioration, for example. The feature of displaying the “method for mending/repairing use deterioration or natural deterioration of multiple first devices (products)” is explained next. A method for mending/repairing in a case similar to currently occurring use deterioration or natural deterioration may be displayed, for example, by accumulating a large amount of data of use deterioration information and natural deterioration information on multiple first devices and multiple third devices compared with the first devices, and accumulating a large amount of information on circumstance and history in which the use deterioration and natural deterioration states have reached mending/repair, and on circumstance, history and the like in which said deterioration states have reached abnormality, to analyze big data.

In addition, a method for solving by consulting a support personnel or a method for solving by requesting a mending/repairing company, for example, on the basis of the analysis result of the big data, may be displayed.

The feature of displaying the “prediction of mending/repair cost for use deterioration and natural deterioration of a product and other products compared with the product” is explained next. It is also possible to display the prediction of mending/repair cost for use and natural deteriorations in such a manner similar to the method described in the preceding paragraph [0048] above.

In other words, when a large number of mending/repair cases including mending/repair cost is collected from information on cases of use deterioration and natural deterioration of multiple first devices, for example, and analyzed, it is possible to display prediction having an increased probability of a mending/repair cost of use deterioration or natural deterioration, to which a predetermined first device currently needs to correspond, by reading out a mending/repair cost for a case comparable to the currently occurring use deterioration or natural deterioration among the mending/repair fees analyzed above.

In addition, the present invention comprises a mending/repair support information display unit, so that it is possible to introduce mending/repair companies and network the mending/repair companies, as to be discussed later.

Accordingly, with respect to a problem in which a use deterioration or natural deterioration has been discovered and it has been predicted that mending/repair is necessary, for example, it is also possible to acquire a quotation for mending/repair from a mending/repairing company, and display the quotation.

Furthermore, it is possible to provide a prediction of further mending/repair, by collecting, accumulating and analyzing said quotation information over a long period of time.

Moreover, a service (such as chat service and mail service) may be provided, depending on the situation, in which it is possible to consult mending/repair companies and the like, and acquire quotations therefrom, for example, via a first network.

The feature of displaying the “most appropriate mending/repair time for use deterioration and natural deterioration of a product and other products compared with the product” is explained next.

The “the most appropriate mending/repair time for use deterioration and natural deterioration” can be defined as a mending/repair time at which, while a state of use deterioration or natural deterioration is displayed, for example, and when the most appropriate mending/repair time thereof has been missed, it is highly probable that the use deterioration and natural deterioration further progress, and the first device (products) is seriously damaged, whereby further risks of unavailability, replacement and the like thereof occur.

With respect to a usage in which there is a possibility for use deterioration and natural deterioration of a product (first device) to seriously damage the product and the user of the product, some manufactures of the product and product safety/quality research organizations (National Institute of Technology and Evaluation in Japan, Underwriters Laboratories in the USA, other international organizations for standardization and participating organizations thereto, Consumer Product Safety Commission, and the like) provide attention information pertaining to use frequency, use period, use environment and the like, and thresholds at which the safety and quality are threatened.

It is possible to display the most appropriate mending/repair times for use deterioration and natural deterioration in the multiple first devices, by storing, in a storage unit, thresholds at which the safety and quality are threatened, and other attention information disclosed by the product manufacturer and product safety/quality research organizations, for example, and using the stored threshold information, attention information and the like, and information on use deterioration or natural deterioration of multiple first device, which a deterioration/abnormality analysis support information display unit acquires, to collate the same in the first devices or the second devices.

In addition, it is also possible to display a state of use deterioration and natural deterioration, at which it is the most appropriate time for mending/repairing the deteriorations, by collecting and analyzing a number of cases where multiples first devices are mended/repaired according to use deterioration information and natural deterioration information thereon, and a number of cases where multiple first devices have not been mended/repaired according thereto and reached thereafter abnormality states.

Furthermore, related advices and the like may be provided by connecting to support personnel, for example, depending on the situation.

The feature of displaying the “mending/repair companies for use deterioration and natural deterioration of a product and other products compared with the product” is explained next. First, a mending/repair support information display unit in each of multiple first devices displays and introduces one or more mending/repair companies (mending/repair companies) when a deterioration or abnormality has occurred to the product (first device) and a user of the product has required for mending/repair.

The mending/repair support information display unit in each of the multiple first devices may display and introduce one or more mending/repair companies when the user of the first device desires to mend/repair the first device (may be displayed when the user clicked a predetermined position on a display section created by html language, for example), on the basis the deterioration/abnormality analysis support information, for example.

The one or more mending/repair companies to be introduced may be stored separately in advance in a storage unit in the multiple first devices or the one or more second devices, for example, and displayed thereafter.

The mending/repair support information display unit may acquire location information on the first device requiring mending/repair, and display one or more mending/repair companies in the neighborhood thereof, for example, on the basis of the acquired location information.

In addition, a service (such as chat service and mail service) may be provided, depending on the situation, in which it is possible to consult mending/repair companies and the like, and acquire quotations therefrom, for example, via a first network.

Here, the “most appropriate mending/repairing company for use deterioration and natural deterioration of a product and other products compared with the product” may be a mending/repairing company having good reputation by users for use deterioration and natural deterioration, for example.

The first method for displaying the “most appropriate mending/repairing company for use deterioration and natural deterioration” may be a method in which, when one or more mending/repair companies to be introduced are stored in advance in a storage unit in the first devices or the second devices, for example, deterioration mending/repair companies having good reputation by users are selected and stored by referring to mouth-to-mouth information and review information on the Internet, to display.

In addition, the mending/repair support information display unit maybe configured so as to be capable of, when introducing deterioration mending/repair companies to users of multiple first devices (products), for example, collecting evaluation information such as thought and opinion on the deterioration mending/repair companies to be introduced, and analyzing the collected multiple pieces of evaluation information on the deterioration mending/repair companies, to thereby collect/accumulate information on the most appropriate multiple deterioration mending/repair companies, and display the most appropriate deterioration mending/repair companies having good reputation.

Furthermore, it may be possible to use organizations and networks, for example, to which a number of deterioration mending/repair companies participate, thereby introducing deterioration mending/repair companies, and having the organization side manage the deterioration mending/repair companies having good reputation.

Use deteriorations and natural deteriorations of a product and other products compared with the product have been explained up to this point.

Abnormalities of multiple first devices (products) and other products compared with the products are explained next.

Here, an abnormality of a first device (product) is defined as something different (different state) from usual other than the abovementioned use deterioration and natural deterioration states.

Usually, an abnormality serves as a signal or trigger, for example, which leads to a state such as nonconformity, defect and failure.

Such nonconformity, defect and failure are not fixed in definition, but failure may include nonconformity and defect here.

A failure may be defined as a deviation state from some reference. An abnormality may be predicted to occur on the basis of contents of use state information and user habit information displayed by the use state/situation support information display unit.

The feature of displaying the past, present and future abnormality content, using the deterioration/abnormality analysis support information display unit, is explained here. Abnormalities occurring to a first device include an abnormality occurring in a case where the same or the same kind of abnormality occurs in chronological order, and an abnormality occurring in a case where an individual abnormality occurs just once.

When an abnormality (including accident) occurring just once occurred in the past, abnormality information may be stored in a storage unit in the second device, for example, and read out and displayed today as the past information.

When an abnormality occurring just once occurred today, abnormality information is displayed and stored as the present information, and will be displayed today tomorrow as the past information.

In a case where the same or the same kind of abnormality occurs in chronological order, abnormality information on a vehicle in an abnormality state, with which it was difficult to start the engine at a cold cay one year ago, and it is difficult to start the engine today, for example, is displayed as the current abnormality information.

When the abnormality state (such as the number of trials to start an engine) where it was difficult to start the engine one year ago was stored in a storage unit along with the time at which the abnormality occurred, the abnormality state is read out and displayed today as the past information.

In addition, if an abnormality state (such as the number of trials to start an engine) where it is difficult to start the engine today is displayed along with the past abnormality information, it means that the present abnormality is displayed.

Furthermore, when the today's number of trials to start an engine is extremely larger than the past number of trials to start the engine, it is also possible to determine that the today's abnormality is an abnormality to which a particular attention should be paid, for example.

Note that when the present abnormality information on each of multiple first devices is stored in a storage unit along with time, the present abnormality information will be displayed as the past abnormality information at a time after tomorrow when the present became the past.

Accordingly, it will be also possible to confirm and evaluate the current progress of the abnormality at some time in the future.

It may be possible to predict, display a future abnormality of a predetermined first device by collecting, accumulating and analyzing information on the present abnormality such as abnormality information on other first devices having different purchased times and used times, and progress situation information thereon, and provide advices for preventing abnormalities that are likely to occur in the future.

Note that information pertaining to future abnormalities is not limited to the examples listed here, but may be any other information as far as a future abnormality can be predicted with said information on the basis of the use state information, use habit information or the current abnormality information on the first device.

The “abnormality content and cause or factor of a product and other products compared with the product” displayed by the deterioration/abnormality analysis support information display unit is explained here.

A method in which the use state/situation support information display unit acquires use state information and user habit information is previously mentioned.

Again, the deterioration/abnormality analysis support display unit displays information on the basis of use state/situation support information.

Contents of use state information and user habit information, which are content of abnormality and the cause or factor thereof, are mentioned in paragraphs [0023] and [0025] of the present patent specification.

When detecting abnormality information in such a manner as detecting the deterioration information, threshold information with which it is possible to identify that the quality and performance of a first device (product) are in an abnormality state may be stored in a storage unit in the first device or the second device, for example, and various kinds of sensors, diagnostic equipment and the like mounted to the first device may display an abnormality state when the threshold has been exceeded.

In addition, with respect to abnormalities which the sensors and the like hardly detect, information on the contents of the abnormalities and the causes thereof, for example, may be inputted, collected and compiled to a database by users of the multiple first devices, thereby displaying, to users of other first devices, the contents of abnormalities and factors using the abovementioned big data analysis method.

Note that the methods for acquiring, displaying and predicting information on causes or factors of abnormalities are not limited to the examples listed here, but may be any other method for an information on causes or factors of abnormalities as far as said information is information (quality and performance information) on state pertaining to motion, work, action, function, operation, working, calculation, information processing or behavior of the multiple first devices and can be acquired and displayed by the use state/situation support information display unit.

The feature of displaying “necessity of mending/repairing abnormalities of a product and other products compared with the product” is explained next.

Methods for displaying the past, present and future abnormality information and for acquiring and displaying the causes and factors of abnormalities have been explained up to this point. Information on abnormalities occurred in multiple first devices (products) is exchanged between the multiple first devices and one or more second devices via a first network.

Accordingly, a large amount of abnormality information on multiple first devices and multiple third devices compared with the first devices is stored in a storage unit in the second devices or first devices, and

it is possible to acquire history information and the like on histories in which those abnormality states have reached mending/repair or replacement, by continuously making use of the abovementioned big data analysis method, for example. It is possible to display the necessity of mending/repairing an abnormality of a first device currently being used in a state of the abnormality, using the big data analysis method, as information with an increased probability.

The feature of displaying “a prediction of costs for mending/repairing abnormalities of a product and other products compared with the product” is explained next. The prediction of costs for mending/repairing abnormalities can also be displayed by a method similar to that described in the preceding paragraph [0060].

In other words, it is possible to display prediction of a mending/repair cost with an increased probability by collecting and analyzing a large number of mending/repair cases including mending/repair costs from the abnormality history information on multiple first devices, to thereby read out a mending/repair cost comparable to currently occurring abnormality from the analyzed mending/repair costs, when mending/repairing an abnormality currently requiring correspondence in a predetermined first device.

In addition, the present invention comprises a mending/repair support information display unit, which is discussed later, so that it is possible to introduce mending/repair companies and network those companies.

Accordingly, with respect to a problem in which, for example, an abnormality is discovered and it is necessary to mending/repair, it is possible to get a quotation from a mending/repairing company, and display the quotation. Furthermore, it is possible to provide a prediction for further mending/repair by collecting and analyzing the quotation information over a long time.

The feature of displaying the “most appropriate mending/repair times for abnormalities of a product and other products compared with the product” is explained next.

The “most appropriate mending/repair time for an abnormality” can be defined as a mending/repair time at which, when the most appropriate mending/repair time has been missed while an abnormality is displayed, for example, it is highly probable for the abnormality to further progress, thereby seriously damaging the first device (product), and generate further risk of unavailability, replacement and the like.

With respect to a usage in which there is a possibility for an abnormality of a product (first device) to seriously damage the product and the user of the product,

some manufactures of the product and product safety/quality research organizations (National Institute of Technology and Evaluation in Japan, Underwriters Laboratories in the USA, other international organizations for standardization and participating organizations thereto, Consumer Product Safety Commission, and the like) provide attention information pertaining to use frequency, use period, use environment and the like, and thresholds at which the safety and quality are threatened.

It is possible to display the most appropriate mending/repair times for abnormalities in multiple first devices, by storing, in a storage unit, thresholds at which the safety and quality thereof are threatened and other attention information disclosed by the product manufacturer and product safety/quality research organizations, for example, and using the stored threshold information, attention information and the like, and information on abnormalities of multiple first device, which a deterioration/abnormality analysis support information display unit acquires, to collate the same in the first devices or the second devices.

In addition, it is possible to display a state of an abnormality, at which it is the most appropriate time for mending/repairing the abnormality, by collecting and analyzing a number of cases where multiples first devices are mended/repaired according to abnormality information thereon, and cases where multiple first devices have not been mended/repaired according thereto and reached thereafter abnormality states.

The feature of displaying the “most appropriate mending/repairing company for abnormalities of a product and other products compared with the product” is explained next. First, a mending/repair support information display unit in each of multiple first devices displays and introduces one or more mending/repair companies (mending/repair companies) when a deterioration or abnormality has occurred to the product (first device) and a user of the product has required for mending/repair.

The one or more mending/repair companies to be introduced may be stored separately in advance in a storage unit in the multiple first devices or the second devices, for example, and displayed thereafter.

The mending/repair support information display unit may acquire location information on the first device requiring mending/repair, and display one or more mending/repair companies in the neighborhood thereof, for example, on the basis of the acquired location information.

Here, the “most appropriate mending/repairing company” may be a mending/repairing company having good reputation by users, for example.

The first method for displaying the “most appropriate abnormality mending/repairing company” may be a method in which, when one or more mending/repair companies to be introduced are stored in advance in a storage unit in the first devices or the second devices, for example, mending/repair companies having good reputation by users are selected and stored by referring to mouth-to-mouth information and review information on the Internet, to display.

In addition, the mending/repair support information display unit maybe configured so as to be capable of, when introducing abnormality mending/repair companies to users of multiple first devices (products), for example, collecting evaluation information such as thought and opinion on the abnormality mending/repair companies which have been introduced, and analyzing the collected multiple pieces of evaluation information on the abnormality mending/repair companies, to collect and accumulate information on the most appropriate multiple abnormality mending/repair companies, and display the most appropriate abnormality mending/repair companies having good reputation.

Furthermore, it may be possible to use organizations and networks, for example, to which a number of abnormality mending/repair companies participate, thereby introducing abnormality mending/repair companies, and have the organization side manage the abnormality mending/repair companies having good reputation.

The feature of displaying resale support information by the resale support information display unit, said information pertaining to resale in the past, present and future, is explained next.

Information pertaining to resale includes the past, present and future resale price prediction information on the multiple first devices, asset value evaluation information, information on the most appropriate resale time (sale time) and the most appropriate buying company based on the resale price, and the like.

As an effect of displaying resale support information on a first device,

it is possible for each of users of multiple first devices to know resale price prediction, asset value evaluation, the most appropriate resale time (sale time) and the like for the first device while using the first device (in real time), to use said information as a reference for determining replacement to a next device and set up a financial plan based on the asset value. In addition, when resale support information on multiple first devices is displayed, it is possible for an owner of each of the multiple first devices, for example, to understand that the resale price prediction varies depending on usage and handling method (including accident) of the first device, and

it is possible to provide an advice by analyzing, in the second device, the reason of the variation,

and improve the usage and handling method of the first device by displaying resale price prediction of the first devices which have been purchased at the same time, in a ranking format in descending order of the price, for example.

The resale support information display unit performs at least one of calculation, analysis and acquisition of resale support information on multiple first devices on the basis of at least one piece of the use state/situation support information, deterioration/abnormality analysis support information and mending/repair support information, to generate and display the result.

The resale support information that a resale support information display unit displays is preferably generated and displayed by performing at least one of calculation, analysis and acquisition of resale support information on multiple first devices on the basis of the use state/situation support information, the deterioration/abnormality analysis support information and the mending/repair support information. The resale support information display unit may check the following items and set evaluation point or an coefficient to each item, thereby predicting resale prices, on the basis of the use state/situation support information, the deterioration/abnormality analysis support information and the mending/repair support information.

1. Check items to be assessed on exterior (body, etc.)

Degree of entire body dirt,

number and degree of body dents,

number and condition of body scratches,

scratches on key holes and around doors,

condition of doors, behavior of windows,

condition of radio and TV antennas,

condition of head lamps, tail lamps and other lamps,

condition of bonnet and ceiling,

condition of moon roof behavior, condition of sunroof behavior,

condition of aero parts, front condition, rear condition,

condition of side glasses and

body color (popular color or unpopular color)

2. Check items to be assessed on interior (inside vehicle)

Condition of dirt inside the whole vehicle,

presence/absence of smoking (smell, tar), seat condition,

condition and presence/absence of floor mat dirt,

condition of audio equipment and speakers,

condition of car navigation, condition of steering wheel and meters,

airbag condition, spare tire condition,

condition of equipment accessories and

degree of trunk room dirt

3. Check items to be assessed on engine room

Engine condition, battery condition,

engine oil condition,

presence/absence of remodeled parts and the history thereof (frame check), vehicle identification number

4. Check items to be assessed on undercarriage and underbody (tire-related items)

Condition of tires and wheels,

tire house condition,

condition of vehicle height (suspensions, shock absorbers, etc.), condition and degree of dent in each part,

condition and degree of dirt and rust in each part, muffler condition, and

condition of oil leakage and bleeding

5. Check items to be assessed on entire vehicle and other parts Model, manufacturer, grade, model year, running distance, vehicle verification (remaining period),

presence/absence of documents such as instruction manual, history content in maintenance records, presence/absence of genuine parts, and

presence/absence of spare keys and keyless system Note that there may be check items other than those described above.

The abovementioned check items may be acquired by various kinds of sensors, measurement equipment, diagnostic measurement equipment, monitoring and alarm equipment, and the like, for example, as previously mentioned, or

may be acquired by inputs by users of first devices (text input or voice input), imaging or the like,

thereby storing the acquired check items in a storage unit, or displaying the check items on a display unit, and displaying resale price prediction on a resale support information display unit, using the check items.

The contents of and methods for displaying the use state/situation support information, the deterioration/abnormality analysis support information and the mending/repair support information have been explained up to this point.

Information pertaining to resale of multiple first devices, which a resale support information display unit displays, in generated and displayed by using cost (acquisition time cost) at the time of purchasing each of the multiple first devices as basic information, for example, adding contents and display pertaining to the use state/situation support information, the deterioration/abnormality analysis support information and the mending/repair support information to the basic information, and performing at least one of calculation, analysis and acquisition in general of the information.

The feature of “generating and displaying by performing at least one of calculation, analysis and acquisition in general” may mean, for example,

to evaluate, in an evaluation point system, or give predetermined evaluation coefficients to, in advance, the conditions and situations represented by the use state/situation support information, the deterioration/abnormality analysis support information and the mending/repair support information, according to the conditions and situations, such that the evaluation can easily be used for the calculation, analysis and the like, and to use the evaluation system and evaluation coefficients to the basic information on the cost (acquisition time cost) at the time of purchasing each of the multiple first devices, thereby displaying resale price prediction information.

In other words, when a predetermined first device, of which the use situation in the use state/situation support information is displayed, has been used for five years, for example, a numerical value may be set by multiplying the purchase price of the first device with 0.5 by using an evaluation point system (in which product value is set to reduce to zero when the product has been used for ten years, for example) of the resale price prediction led by years of ownership, or

a numerical value may be set by reducing from the purchase price 10% thereof if the product has a history of any abnormality and mending/repair thereof, which is in the display of the deterioration/abnormality analysis support information.

These evaluation point and evaluation coefficient may be led by accumulating and analyzing, in the one or more second devices, the use state/situation support information, the deterioration/abnormality analysis support information, the mending/repair support information and the like on multiple first device, or may be set by referring to an existing pricing method in used commodity market, to the accumulated information, for example.

Note that the method for “generating and displaying by performing at least one of calculation, analysis and acquisition in general” is not limited to the examples listed here, but may be any other method as far as at least one of calculation, analysis and acquisition in general is performed in said method, on the basis of at least one piece of the use state/situation support information, the deterioration/abnormality analysis support information and the mending/repair support information on multiple first devices.

The feature of displaying the past, present and future resale price prediction information on multiple first devices (products) and other products compared with the products is explained here.

In displaying use situation in the use state/situation support information on multiple first devices, for example, it is possible to calculate the present resale price prediction and asset value prediction on the basis of year of use or time of use, and the like thereof such as a year of use for eight years or a time of use for 12,000 hours, for example.

In addition, when it is found that the year of use of the first device was five years or the time of use thereof was 7,500 hours three years ago, it is possible to calculate and analyze the past resale price and asset value on the basis of said feature, and display an asset value prediction on the basis thereof.

Furthermore, it is possible to predict a future year of use or time of use by analyzing year of use or time of use (maybe running distance of a vehicle) from the past to the present in the use state in the use state/situation support information on multiple first devices (products), and display a future resale price prediction or an asset value prediction on the basis of the prediction.

Moreover, the feature of displaying the past, present and future information on a product and other products compared with the product in displaying the use state/situation support information, the deterioration/abnormality analysis support information and the mending/repair support information on multiple first devices has been explained, but it may be possible to display the past, present and future resale price prediction information on the basis the displayed past, present and future information.

A resale support information display unit displays also asset value information on the basis the resale price prediction of multiple first devices, as mentioned above.

Asset value information on a first device serves as important information for large organizations possessing multiple first devices or owners of expensive first devices, which influences asset value evaluation or financial plan thereof.

Note that it would be necessary for the asset value information to maintain certain accuracy for being important information. According to the present invention, asset value evaluation of multiple first devices is performed on the basis of the resale price prediction mentioned above, so that it is possible to display the asset value evaluation while maintaining certain accuracy.

More specifically, the certain accuracy is achieved in the abovementioned resale price prediction, for example, on the basis the accident situation and history, mending/repair history, use deterioration information such as acceleration information and vibration information, natural deterioration information, abnormality information and user habit information on each first device, which are obtained by various sensors mounted to the first device or inputted by the user thereof, so that it would be possible to predict a resale price with accuracy higher than those predicted by professional assessment agencies in a real-time manner.

The most appropriate resale time (sale time) for multiple first devices (products) and other products compared with the products is explained next.

First, the most appropriate resale time is explained here. The most appropriate resale time may be defined as a time which is desired for verification when an owner (user) of a fist device purchases a device (may be the same model or a different model) which serves as a new first device, for example.

In other words, when determining the most appropriate resale time on the basis of a pure cost comparison, the most appropriate resale time may be displayed basically by comparing annual average costs, for example, in a case of (1) purchasing a new first device model after the previous first device has been used until disposal thereof (at a resale price of zero), and in a case of (2) purchasing a new first device model at a certain time at which the previous first device still has a resale value.

In addition, there is a case where the most appropriate resale time is determined on the basis of, in addition to pure costs, comparison of costs in which costs associated with efficiency/productivity, costs associated with safety and other costs are aggregated, for example.

In other words, when comparing quality and performance of the existing first device with those of new models of the first device, which are sold every year, and the quality and performance of the new model are largely improved, so that t is possible to predict that the general cost advantage derived from the improved quality and performance is large, it may be important to determine the most appropriate resale time.

The resale support information display unit may display the most appropriate times of a first device (product) and other products compared with the product by storing, in a storage unit in one or more second devices, the most appropriate resale times of multiple first devices and the most appropriate resale times, analysis reason therefor and analysis data of multiple third devices compared with the first devices, collecting a number of those big data, and analyzing the big data.

Here, potential elements those are used for calculation, analysis and evaluation when displaying the most appropriate resale time (sales time) in a case where the first device is a vehicle are listed below.

Purchase price, model and model number of the vehicle; the number of years until resale or disposal of the vehicle; running distance until resale or disposal of the vehicle; cost allocation (energy cost increase due to fuel consumption deterioration, tax burden increase due to environment reduction and use of old-model number vehicle, etc.) due to deterioration of vehicle quality and performance;

vehicle mending/repair cost increase;

environmental car tax reduction (eco-car tax reduction) when replacing to a new vehicle;

interest rate difference between loan at purchase time and the current loan;

whether trade-in to a new car dealer or purchase by a used car dealer;

accident history; and other elements.

The appropriate resale time may be displayed by analyzing, calculating and evaluating in general whether it is beneficial to purchase a new first device model after having used the currently possessing vehicle until disposal thereof, or it is beneficial to resale the vehicle now or at a future time and purchase a new first device model, for example, combining those elements.

In addition, in the abovementioned examples, it is attempted to display the most appropriate resale time on the basis of a cost relation between the currently using vehicle and a new vehicle model to be purchased, but it may be possible to try displaying the most appropriate resale time by analyzing costs of vehicles including a new vehicle model to be purchased next to the next one, or further including use cost analysis of previously used vehicles.

A buying company information display unit which displays, as buying company information, information on buying companies for each of the multiple first devices, on the basis of the resale support information is explained next.

The buying company information display unit in a first device may display and introduce on or more buying companies on the basis of the resale support information when a user of the first device desires resale of the first device (said request may be indicated by a click by the user on a predetermined place on a display section created in html language, for example). One or more buying companies to be introduced may be stored separately in advance in storage units in the multiple first devices or the one or more second devices, and read out and displayed, as needed, when the use of the first device desires resale of the first device, for example.

The buying company information display unit may acquire location information on the first device requiring for resale from a location information display unit, and display one or more buying companies in the vicinity thereof, for example, on the basis of the acquired position information.

Here, the “most appropriate buying company” may be a buying company having good reputation by users, for example.

The first method for displaying the “most appropriate buying company” may be a method in which, when one or more buying companies to be introduced are stored in advance in a storage unit in the first devices or the second devices, for example, buying companies having good reputation by users are selected and stored by referring to mouth-to-mouth information and review information on the Internet, to display.

In addition, the buying company information display unit may be configured so as to be capable of, when introducing buying companies to users of multiple first devices (products), for example, collecting evaluation information such as thought and opinion on the buying companies to be introduced, and analyzing the collected multiple pieces of evaluation information on the buying companies, to collect and accumulate information on the most appropriate multiple buying companies, and display the most appropriate buying companies having good reputation. Furthermore, it may be possible to use organizations and networks, for example, to which a number of buying companies participate, thereby introducing buying companies, and have the organization side manage the buying companies having good reputation.

The economy/environment/safety support information display unit which displays, as economy/environment/safety support information, the past, present and future economy information, environment information or safety information on each of the multiple first devices, on the basis of at least one piece of the use state/situation support information, the deterioration/abnormality analysis support information, the mending/repair support information, the resale support information and the buying company information is explained next.

The economy information on each of the multiple first devices may be displayed by comprehensively analyzing, for example, costs required for purchasing (initial costs such as purchase price, various fees and various taxes) and costs for using after purchase (running costs such as energy fee, mending/repair cost and other usage fees which generate when using the first device).

The purpose of displaying the economy information on each of the multiple first devices is to compare the respective pieces of information on the multiple first devices, display a ranking of economy thereof at times, or model a usage of a first device having excellent economy, thereby providing a benefit to each of the users of the firsts devices.

The environment information on each of the multiple first devices may relate to energy efficiency of each of the multiple first devices, or pertain to generation and generation amount of an article, such as material, sound, vibration and wave, which is caused by using each of the multiple first devices and adversely influences on natural environment, human body and the like.

Note that the purpose of displaying the environment information is similar to the purpose of displaying the economy information.

The safety information on each of the multiple first devices may be information on events leading to an adverse influence on natural environment, human body and the like, such as injury, disease and serious accident, for example, which is caused by abnormality, deterioration and the like or human behavior and operation of the multiple first device, or information on events leading to threatening of various kinds of security (including both of hardware and software).

Note that the purpose of displaying the safety information is similar to the purpose of displaying the economy information.

The feature of displaying economy, environment and safety by the economy/environment/safety support information display unit is explained here.

Economy of multiple first devices (vehicles) may be displayed by, for example:

attaching identification information to a pair of a first time at which an engine (or power) of a vehicle has been started, and a second time at which the engine (or power) thereof has been stopped thereafter, to configure identification-attached first time/second time information, and linking the running distance from the first time to the second time, and consumption of energy consumed during the running distance, with the identification-attached first time/second time information, to configure identification-attached vehicle running information and store said pieces of information in a storage unit;

using the stored pieces of information and energy prices (price per litter for gasoline) which has been separately acquired in advance, to calculate a consumption cost of energy consumed during the running distance; and

calculating an average vehicle speed from the first time to the second time.

Publicly-known features or other features, such as measurement by a sensor disposed to an output shaft in a transmission, for example, may be used for measuring the running distance. In addition, Publicly-known features or other features, such as float arm type and cross coil type measurement, for example, may be used for measuring the energy consumption (calculation of a difference between the remaining energy levels at the first time and the second time).

Furthermore, “JP 1975-2130”, “JP 1994-167551”, etc., for example, each disclose a method for detecting a remaining capacity of a rechargeable battery, but any detection method may be used for detecting a remaining capacity of a rechargeable battery.

Note that in calculating the average vehicle speed, vehicle stop time due to stopping at traffic lights while moving from the first time to second time, for example, is included in the calculation, so that the vehicle stop time may be used as an important element in verification of idling time cost at the stopping and comparison with other running routes and running economy at different periods of time.

Moreover, in addition to the identification-attached vehicle running information, identification-attached vehicle running/route information which is configured by acquiring a vehicle running route from existing map information or by using a vehicle-mounted GPS, and linking the acquired vehicle running route to the identification-attached vehicle running/route information, may be stored in a storage unit.

The most economical running time, running route, running method, average vehicle speed and the like may be displayed by collecting and analyzing a number of pieces of the identification-attached vehicle running/route information at multiple identification-attached n-th times and (n+1)-th times during periods different from the period from the first time to second time, using one or more second devices, for example. According to display of these vehicle economies, vehicle economy at an arbitrary time in the past may be displayed, for example, and a prediction of future vehicle economy may be displayed by analyzing numerical change transition of vehicle economy from the past to the present.

In addition, second economy information may be displayed by adding purchase cost of a vehicle to economy information on the vehicle, which is obtained by the identification-attached vehicle running/route information from multiple identification-attached n-th times to (n+1)-th times.

For example, economy may be displayed by calculating a sum of energy consumption cost for a predetermined running distance and the purchase cost, and compared with economies of other first devices (vehicles).

Furthermore, economy per unit running distance may be displayed by dividing the sum of energy consumption cost for a predetermined running distance and the purchase cost with the running distance, compared among multiple first devices, and displayed in ranking.

Moreover, it may be possible to configure in such a manner as to store, in a storage unit, the identification-attached vehicle running/route information during a third time to a fourth time, and an n-th time to an (n+1)-th time, such as the first time to second time, and

display the multiple pieces of the identification-attached vehicle running/route information within a predetermined period (specified year, month and time, for example) from 8 in the morning to 5 in the afternoon of August 2016, for example, from among the stored multiple pieces of the identification-attached vehicle running/route information.

It may be thereby possible to configure in such a manner as to be capable of analyzing economical running route and running method of a vehicle of a predetermined driving personnel within working hours of a day.

In addition, when analyzing economic running routes from among the multiple pieces of identification-attached vehicle running/route information, it may be possible to analyze the acquired and stored existing multiple pieces of map information by an image analysis method.

Furthermore, when the drive start time detection unit detects an engine drive start time (time at which vehicle engine is started) of the engine or the like, for example, as a drive start time, it may be possible to generate a vehicle running information measurement start trigger accordingly, and store the detected drive start time to a storage unit while starting, in accordance with the vehicle running information measurement start trigger, measurement of vehicle running distance after the drive start time and consumption of energy consumed during the running time by each of a running distance measurement unit and a drive energy measurement unit, and when the drive stop time detection unit detects an energy drive stop time (time at which a vehicle engine is stopped) of the engine or the like, as a drive stop time, it may be possible to generate a vehicle running information measurement stop trigger accordingly, store the time in a storage unit, stop measurement of vehicle running distance and consumption of energy consumed during the running distance in accordance with the vehicle running information measurement stop trigger, and attach identification information to the measured values along with the drive start time and the drive stop time stored in the storage unit, to generate identification information-attached vehicle running information, and the economy/environment/safety support information display unit may store information in any storage unit in the first devices or the one or more second devices, and read out/display information from the storage unit, as appropriate.

Method for generating the identification information-attached vehicle running information is not limited to the examples listed here, but may be any other method as far as a vehicle running distance and an consumption of energy consumed during the vehicle running distance are measured, in said method, on the basis of times detected by the respective detection units, identification information is attached to at least one piece of information on measured values or the respective pieces of time information, and two or more pieces of said information are linked and generated.

Moreover, the vehicle running information measurement start trigger and the vehicle running information measurement stop trigger are generated on the basis of detection of the drive start time of engine or the like and the drive stop time of engine or the like by the drive start time detection unit and the derive stop time detection unit, and

measurement of vehicle running distance after the drive start time and the start and stop of consumption measurement of energy consumed during the running distance are automatically performed, but when it is desired to measure a vehicle running distance from a predetermined time to a predetermined time and consumption of energy consumed during the running distance, for example, a vehicle driver may input the desired measurement start time and measurement stop time using a button input unit or voice input unit, to store the inputted times respectively to a storage unit, and start measurement using the inputted times as the measurement start and stop triggers for the measurement.

Environment of multiple first devices (vehicles) may be displayed and compared by calculating amounts of heat-trapping gasses discharged by vehicles having run a predetermined distance, for example.

Methods for calculating CO2 discharge amount based on running distance of a vehicle and fuel efficiency of said vehicle, for example, are widely published so that any such method may be used. In addition, it may be possible to use the identification-attached vehicle running information and the identification-attached vehicle running/route information, to calculate an amount of heat-trapping gasses discharged by a vehicle.

According to the usage, it is possible to display or predict the past, present and future environment, such like the economy, on the basis of each of stored measurement times and vehicle running distance linked thereto, for example.

Safety of multiple first devices (vehicles) may be displayed on the basis of the use deterioration information, the natural deterioration information and the abnormality information, for example.

Displaying the use deterioration information, the natural deterioration information and the abnormality information in the past, present and future is explained above, but the safety also may be displaying by means of the method of displaying use deterioration information, natural deterioration information and abnormality information in the past, present and future.

The new device purchase support information display unit which displays, as new device purchase support information, at least one piece of support information pertaining to purchase of new device and finance trader information at the time of purchasing a new device, on the basis of at least one piece of the use state/situation support information, the deterioration/abnormality analysis support information, the mending/repair support information, the resale support information, the buying company information and the economy/environment/safety support information, is explained next.

If the time has come, at which a user (owner) of each of multiple first devices desires and considers purchase of a new device such as a newly sold first device model for some reason while using said first device, it may be possible to provide new device purchase support information, in order to support the desire and consideration.

The new device purchase support information display unit in the multiple first devices may display and introduce one or more new device dealers when a user (owner) of each first device desires and considers purchase of a new device (which may be displayed by clicking by the user on a predetermined place of a displayed portion created by html language, for example).

The one or more new device dealers to be introduced may be stored separately in advance in a storage unit in the multiple first devices or the one or more second devices, for example, and read out and displayed if the user of the first device desires to purchase a new device.

The new device purchase support information display unit may acquire location information on the first device, the user of which desires purchase of a new device, for example, from the location information display unit, and display one or more new device dealers in the neighborhood thereof.

The “most appropriate new product information on a product and other products compared with the product” which the new device purchase support information display unit displays is explained next.

Methods for collecting, analyzing and providing, to users of multiple first devices, the past, present and future use state information, use situation information and user habit information, information pertaining to the past, present and future deterioration and abnormality, information pertaining to the past, present and future resale, buying company information, the past, present and future economy information, environment information or safety information, and the like on a user of each of multiple first devices are explained up to this point.

The first method for displaying the “most appropriate new product information” is preferably based on collection and analysis results of the information.

For example, it is possible to provide the most appropriate individual new product information to a user of each first device on the basis of the analysis result (by the big data analysis method) of a large amount of use state information, use situation information and user habit information on multiple first devices, for example.

It may be possible to provide information on the most appropriate new products made of materials strong against salt wind deterioration to users of first devices suffering from salt wind deterioration,

provide information on new products having both economy and environment to users of first devices worrying about economy and environment, or

provide information on new products having excellent vibration resistance to users of first devices suffering from abnormality caused by vibration, for example.

In addition, it also may be possible to make use of analysis of various kinds of data on other first devices or third devices compared with the first devices, and provide information on the most appropriate new products (including the most appropriate benefits such as release date, release price and tax reduction information) to a user of a predetermined first device. The second method for displaying “the most appropriate new product information” may be a method in which, when information on one or more new products to be introduced is stored in advance in a storage unit in the first devices or the second devices, for example, information on new products having good reputation by users is selected and stored by referring to mouth-to-mouth information and review information on the Internet, to display. In addition, the new product purchase support information display unit may be configured so as to be capable of, when introducing new product information to users of multiple first devices (products), for example, collecting evaluation information such as thought and opinion on the new products to be introduced, and analyzing the collected multiple pieces of new product information, to collect and accumulate information on the most appropriate new products, and display information on the most appropriate new products having good reputation.

The “most appropriate replacement time” which the new device purchase support information display unit displays is explained next.

The method for displaying said “most appropriate replacement time” may be a method in which said time is displayed on the elements and content explained in “most appropriate resale time”, which are the previously mentioned.

In addition, the “most appropriate replacement time” may be displayed, considering time and condition at which the most appropriate new products are released.

If the multiple first products are vehicles, basic reference element when displaying the “most appropriate replacement time” includes mainly the following items:

1. an average year of ownership of vehicles by vehicle owners and purchasers (considering planned years for replacement);

2. a situation in which a vehicle reselling price becomes to a predetermined percentage or less of a purchase price;

3. a situation in which the fuel efficiency of the vehicle has reduced and increases of running energy consumption cost and discharge amount of heat-trapping gasses become to certain percentages or more; and

4. a situation in which a certain percentage or more of some benefits can be obtained by replacing to a new vehicle of the same model or a new vehicle of a different model or different manufacturer.

Note that the reference element when displaying the most appropriate replacement time is not limited to the examples listed here, but may be any other reference element as far as the new device purchase support information display unit can display said element.

The abovementioned certain percentage may be determined by a vehicle owner, or by experts or specialized agencies related to vehicles, or may be determined by determining average benefit and disadvantage pertaining to replacement of vehicles.

In addition, method for determining the certain percentage is not limited to those listed here, but may be any other method as far as the most appropriate replacement time can be displayed in said method.

The “most appropriate dealer information” which the new device purchase support information display unit displays is explained next. The method for displaying the “most appropriate dealer information” may be a method in which, when information on one or more dealers to be introduced is stored in advance in a storage unit in the first devices or the second devices, information on dealers having good reputation by users are selected and stored by referring to mouth-to-mouth information and review information on the Internet, to display.

In addition, the new device purchase support information display unit may be configured so as to be capable of, when introducing dealer information to users of multiple first devices (products), for example, collecting evaluation information such as thought and opinion on the dealers to be introduced, and analyzing the collected multiple pieces of information on the dealers, to collect and accumulate information on the most appropriate multiple dealers, and display the most appropriate dealers having good reputation.

The most appropriate finance trader information and the like which the new device purchase support information display unit displays is explained next.

First, the new device purchase support information display unit displays asset value information based on resale price prediction, and

Various companies cooperative in various kinds of financing, which understand said asset value information, may be displayed as the most appropriate finance trader information and the like, on the basis of the asset value information to be displayed. The new device purchase support information display unit may be configured so as to share the asset value information with multiple financial companies via a first network in advance or always in real time, for example, in order to display information on the most appropriate finance trader and the like, thereby promoting construction of mutual trust relationship and better understanding of the asset value information through mutual information exchange therebetween.

In addition, the most appropriate finance trader information and the like for users of multiple first devices may be displayed by deriving ideal conditions also with respect to interest rate of finance, repayment period and the like.

Further most appropriated financial companies and the like may be enabled to be displayed by storing, in a storage unit in multiple first devices or one or more second devices, accumulating and analyzing the respective pieces of information which the new device purchase support information display unit displays, for example.

Furthermore, the new device purchase support information display unit may display various kinds of insurance information, insurance producer information and the like at a replacement time of a first device.

The display unit may be configured with, for example, touch panel display, speaker, microphone, camera and the like, and may display information and images that various displays and read-out units, characters that users of first devices inputted, and images and voice such as web information and utilization guidance.

The read-out unit may read out necessary information and desired information under the control of a control unit, as needed and appropriate, from among the respective pieces of information stored in a storage unit.

The control unit may be configured with a central processing unit (CPU) of a computer mounted to the first device or the second device, for example.

Behaviors of a calculation unit in a processor and registers, reading/writing and input/output out/in/to/from storage units may be controlled.

Instructions and program for the control can be constructed by, for example, C++, CGI, JavaScript (registered trademark) and the like.

Note that the instruction method and program may not be particularly limited methods and programs.

In addition, the control unit may comprise a unit for temporarily storing information read out by the read-out unit and/or each piece of information filled by a user.

The examples explained above with respect to the present invention are absolutely examples.

Note that the present invention is not limited to the examples, but may be any invention as far as the claims described in the present invention can be performed by said information, using any feature, elements, order of performances and the like.

The customer support system of the present invention may be an invention of first devices and second devices.

What is claimed is:

1. A customer support system provided with multiple first devices and one or more second devices connected to the multiple first devices via a first network, wherein
each of the multiple first devices is provided with a use state/situation support information display unit which displays, as use state/situation support information, the past, present and future use state information, use situation information and user habit information on each of the multiple first devices, and
a device information display unit which displays, as device information, information representing each of the multiple first devices in order for each of the multiple first devices to transmit/receive information with the one or more second devices via the first network using transmission/reception units described below, and wherein
the multiple first devices and the one or more second devices are provided with transmission/reception units which mutually transmit/receive the use state/situation support information that each of the multiple first devices displays, via the first network using the device information.

2. A customer support system provided with multiple first devices and one or more second devices connected to the multiple first devices via a first network, wherein
each of the multiple first devices is provided with a use state/situation support information display unit which displays, as use state/situation support information, the past, present and future use state information, use situation information and user habit information on each of the multiple first devices,
a deterioration/abnormality analysis support information display unit which displays, as deterioration/abnormality analysis support information, information pertaining to the past, present and future deterioration and abnormality of each of the multiple first devices, on the basis of the use state/situation support information,
a mending/repair support information display unit which displays, as mending/repair support information, at least one of mending/repair methods and mending/repair companies for each of the multiple first devices on the basis of the deterioration/abnormality analysis support information, and a device information display unit which displays, as device information, information representing each of the multiple first devices in order for each of the multiple first devices to transmit/receive information with the one or more second devices via the first network using transmission/reception units described below, and wherein
the multiple first devices and the one or more second devices are provided with transmission/reception units which mutually transmit/receive the use state/situation support information, the deterioration/abnormality analysis support information and the mending/repair support information that each of the multiple first devices displays, via the first network using the device information.

3. A customer support system provided with multiple first devices and one or more second devices connected to the multiple first devices via a first network, wherein
each of the multiple first devices is provided with a use state/situation support information display unit which displays, as use state/situation support information, the past, present and future use state information, use situation information and user habit information on each of the multiple first devices,
a deterioration/abnormality analysis support information display unit which displays, as deterioration/abnormality analysis support information, information pertaining to the past, present and future deterioration and abnormality of each of the multiple first devices,
on the basis of the use state/situation support information, a mending/repair support information display unit which displays, as mending/repair support information, mending/repair methods and mending/repair companies for each of the multiple first devices on the basis of the deterioration/abnormality analysis support information,
a resale support information display unit which displays, as resale support information, information pertaining to the past, present and future resale of each of the multiple first devices, on the basis of at least one piece of the use state/situation support information, the deterioration/abnormality analysis support information and the mending/repair support information,
a buying company information display unit which displays, as buying company information, information on buying companies for each of the multiple first devices, on the basis of the resale support information, and
a device information display unit which displays, as device information, information representing each of the multiple first devices in order for each of the multiple first devices to transmit/receive information with the one or more second devices via the first network using transmission/reception units described below, and wherein
the multiple first devices and the one or more second devices are provided with transmission/reception units which mutually transmit/receive the use state/situation support information, the deterioration/abnormality analysis support information and the mending/repair support information, the resale support information, the mending/repairing company support information, resale support information and buying company information that each of the multiple first devices displays, via the first network using the device information.

4. The customer support system according to claim 1, wherein
each of the multiple first devices is further provided with an economy/environment/safety support information display unit which displays, as economy/environment/safety support information, at least one piece of the past, present and future economy information, environment information and safety information on each of the multiple first devices on the basis of at least one piece of the use state/situation support information, the deterioration/abnormality analysis support information, the mending/repair support information, the resale support information and the buying company information, and
the transmission/reception units in each of the multiple first devices and the one or more second devices further mutually transmit/receive the economy/environment/safety support information on each of the multiple first devices via the first network.

5. A customer support system provided with multiple first devices and one or more second devices connected to the multiple first devices via a first network, wherein
each of the multiple first devices is provided with a use state/situation support information display unit which displays, as use state/situation support information, the past, present and future use state information, use situation information and user habit information on each of the multiple first devices,
a deterioration/abnormality analysis support information display unit which displays, as deterioration/abnormality analysis support information, information pertaining to the past, present and future deterioration and abnormality of each of the multiple first devices, on the basis of the use state/situation support information,
a mending/repair support information display unit which displays, as mending/repair support information, mending/repair methods and mending/repair companies for each of the multiple first devices on the basis of the deterioration/abnormality analysis support information, a resale support information display unit which displays, as resale support information, information pertaining to the past, present and future resale of each of the multiple first devices, on the basis of at least one piece of the use state/situation support information, the deterioration/abnormality analysis support information and the mending/repair support information,
a buying company information display unit which displays, as buying company information, information on buying companies for each of the multiple first devices, on the basis of the resale support information,
an economy/environment/safety support information display unit which displays, as economy/environment/safety support information, the past, present and future economy information, environment information or safety information on each of the multiple first devices, on the basis of at least one piece of the use state/situation support information, the deterioration/abnormality analysis support information, the mending/repair support information, the resale support information and the buying company information,
a new device purchase support information display unit which displays, as new device purchase support information, at least one piece of support information and finance trader information both pertaining to purchase of a new device at the time of purchasing the new device, on the basis of at least one piece of the use state/situation support information, the deterioration/abnormality analysis support information, the mending/repair support information, the resale support information, the buying company information and the economy/environment/safety support information, and a device information display unit which displays, as device information, information representing each of the multiple first devices in order for each of the multiple first devices to transmit/receive information with the one or more second devices via the first network using transmission/reception units described below, and wherein
the multiple first devices and the one or more second devices are provided with transmission/reception units which mutually transmit/receive the use state/situation support information, the deterioration/abnormality analysis support information, the mending/repair support information, the resale support information, the buying company information, the economy/environment/safety support information and the new device purchase support information that each of the multiple first devices displays, via the first network using the device information.

6. The customer support system described in claim 1, wherein
at least any one of the multiple first devices or the one or more second devices is provided with:
a storage unit which stores at least one piece of information that each unit in each of the multiple first devices displays, and information that is transmitted/received by the transmission/reception units, and
an information analysis information display unit which executes at least one of collection, analysis and calculation of each piece of information stored in the storage unit, as information analysis information,
the one or more second devices storing, in the storage unit in the second device, at least one piece of use state/situation support information, deterioration/abnormality analysis support information, mending/repair support information, resale support information, buying company information, economy/environment/safety support information and new device purchase support information on multiple third devices compared with the multiple first devices;
a third device information display unit which acquires, from the one or more second devices via the network using the transmission/reception units in the multiple first devices, and displays at least one piece of use state/situation support information, deterioration/abnormality analysis support information, mending/repair support information, resale support information, buying company information, economy/environment/safety support information and new device purchase support information on multiple third devices compared with the multiple first devices, in each of the multiple first devices;
a display unit which displays at least one piece of information among information displayed on each unit in each of the multiple first devices;
a control unit which controls at least one of the units in each of the multiple first devices;
a location information display unit which displays at least one piece of location information on the multiple first devices and the multiple third devices compared with the multiple first devices; and
second transmission/reception units which mutually transmit/receive, among the multiple first devices via a second network, each piece of information displayed on the units in each of the multiple first devices, and wherein the transmission/reception units in the multiple first devices and the one or more second devices further mutually transmit/receive at least one piece of the location information on the multiple first devices or the multiple third devices compared with the multiple first devices and the information analysis information.

7. The customer support system described in claim 4, wherein when the multiple first devices are vehicles,
the economy/environment/safety support information display unit is further provided with
a drive start time detection unit which detects a vehicle drive start time (time of driving an engine or motor) of the vehicle,
a drive stop time detection unit which detects a vehicle drive stop time of the vehicle,
a running distance measurement unit which starts, when the drive start time detection unit has detected the vehicle drive start time, measurement of a vehicle running distance accordingly after the detection, and stops, when the drive stop time detection unit has detected the vehicle drive stop time, the measurement of the vehicle running distance accordingly after the detection, then displays the measured vehicle running distance, and
a running energy measurement unit which measures a consumption of running energy consumed by the vehicle for funning the vehicle running distance that the running distance measurement unit has measured, wherein
the economy/environment/safety support information display unit is further provided with an identification-attached vehicle running information display unit which attaches identification information to at least one of the vehicle drive start time, the vehicle drive stop time, the vehicle running distance and the running energy consumption, associates (links) two or more of the vehicle drive start time, the vehicle drive stop time, the vehicle running distance and the running energy consumption with one another, to generate identification-attached vehicle running information, and stores the generated identification-attached vehicle running information at least one of storage units in the multiple first devices and the one or more second devices,
an average vehicle speed display unit which uses the vehicle drive start time, the vehicle drive stop time and the vehicle running distance, to calculate an average vehicle speed of the vehicle that has run the vehicle running distance, and an energy consumption cost display unit which uses the running energy consumption and the price of the drive energy per unit, the price having been acquired separately in advance, to calculate a consumption cost of energy that the vehicle has consumed to run the vehicle running distance.

8. The customer support system described in claim 2, wherein
each of the multiple first devices is further provided with an economy/environment/safety support information display unit which displays, as economy/environment/safety support information, at least one piece of the past, present and future economy information, environment information, and safety information on each of the multiple first devices on the basis of at least one piece of the use state/situation support information, the deterioration/abnormality analysis support information, the mending/repair support information, the resale support information and the buying company information, and wherein
the transmission/reception units in each of the multiple first devices and the one or more second devices further mutually transmit/receive the economy/environment/safety support information on each of the multiple first devices via the first network.

9. The customer support system described in claim 3, wherein
each of the multiple first devices is further provided with an economy/environment/safety support information display unit which displays, as economy/environment/safety support information, at least one piece of the past, present and future economy information, environment information and safety information on each of the multiple first devices on the basis of at least one piece of the use state/situation support information, the deterioration/abnormality analysis support information, the mending/repair support information, the resale support information and the buying company information, and wherein
the transmission/reception units in each of the multiple first devices and the one or more second devices further mutually transmit/receive the economy/environment/safety support information on each of the multiple first devices via the first network.

10. The customer support system described in claim 2, wherein:
at least any one of the multiple first devices and the one or more second devices is further provided with a storage unit which stores at least one piece of information that the units in each of the multiple devices display, and information that is transmitted/received by the transmission/reception units, and
an information analysis information display unit which executes at least one of collection, analysis and calculation of each piece of information stored in the storage unit, as information analysis information;
the one or more second devices are each provided with a third device information display unit which stores, in the storage unit of the second device, at least one piece of use state/situation support information, deterioration/abnormality analysis support information, mending/repair support information, resale support information, buying company information, economy/environment/safety support information and new device purchase support information on multiple third devices compared with the multiple first devices, and acquires, from the one or more second devices via the network using the transmission/reception units of the multiple first devices, and displays at least one piece of the use state/situation support information, deterioration/abnormality analysis support information, mending/repair support information, resale support information, buying company information, economy/environment/safety support information and new device purchase support information on multiple third devices compared with the multiple first devices, in each of the multiple first devices,
a display unit which displays at least one piece of information among information displayed on the units in each of the multiple first devices,
a control unit which controls at least one of the units in each of the multiple first devices,
a location information display unit which displays at least one piece of location information on the multiple first devices and the multiple third devices compared with the multiple first devices, and
second transmission/reception units which mutually transmit/receive, among the multiple first devices via a second network, each piece of information displayed on the units in each of the multiple first devices; and
the transmission/reception units in the multiple first devices and the one or more second devices further mutually transmit/receive at least one piece of the location information and the information analysis information on the multiple first devices or the multiple third devices compared with the multiple first devices.

11. The customer support system described in claim 3, wherein:
any one of the multiple first devices and the one or more second devices is further provided with
a storage unit which stores at least one piece of information that the units in each of the multiple devices display, and information that is transmitted/received by the transmission/reception units, and
an information analysis information display unit which executes at least one of collection, analysis and calculation of each piece of information stored in the storage unit, as information analysis information;
the one or more second devices are each provided with a third device information display unit which stores, in the storage unit of the second device, at least one piece of use state/situation support information, deterioration/abnormality analysis support information, mending/repair support information, resale support information, buying company information, economy/environment/safety support information and new device purchase support information on multiple third devices compared with the multiple first devices, and acquires, from the one or more second devices via the network using the transmission/reception units of the multiple first devices, and displays at least one piece of the use state/situation support information, deterioration/abnormality analysis support information, mending/repair support information, resale support information, buying company information, economy/environment/safety support information and new device purchase support information on multiple third devices compared with the multiple first devices, in each of the multiple first devices,
a display unit which displays at least one piece of information among information displayed on the units in each of the multiple first devices,
a control unit which controls at least one of the units in each of the multiple first devices,
a location information display unit which displays at least one piece of location information on the multiple first devices and the multiple third devices compared with the multiple first devices, and
second transmission/reception units which mutually transmit/receive, among the multiple first devices via a second network, each piece of information displayed on the units in each of the multiple first devices; and
the transmission/reception units in the multiple first devices and the one or more second devices further mutually transmit/receive at least one piece of the location information and the information analysis information on the multiple first devices or the multiple third devices compared with the multiple first devices.

12. The customer support system described in claims 4, wherein:
any one of the multiple first devices and the one or more second devices is further provided with
a storage unit which stores at least one piece of information that the units in each of the multiple devices display, and information that is transmitted/received by the transmission/reception units, and
an information analysis information display unit which executes at least one of collection, analysis and calculation of each piece of information stored in the storage unit, as information analysis information;
the one or more second devices are each provided with a third device information display unit which stores, in the storage unit of the second device, at least one piece of use state/situation support information, deterioration/abnormality analysis support information, mending/repair support information, resale support information, buying company information, economy/environment/safety support information and new device purchase support information on multiple third devices compared with the multiple first devices, and
acquires, from the one or more second devices via the network using the transmission/reception units of the multiple first devices,
and displays at least one piece of the use state/situation support information, deterioration/abnormality analysis support information, mending/repair support information, resale support information, buying company information, economy/environment/safety support information and new device purchase support information on multiple third devices compared with the multiple first devices, in each of the multiple first devices,
a display unit which displays at least one piece of information among information displayed on the units in each of the multiple first devices,
a control unit which controls at least one of the units in each of the multiple first devices,
a location information display unit which displays at least one piece of location information on the multiple first devices or the multiple third devices compared with the multiple first devices, and
second transmission/reception units which mutually transmit/receive, among the multiple first devices via a second network, each piece of information displayed on the units in each of the multiple first devices; and
the transmission/reception units in the multiple first devices and the one or more second devices further mutually transmit/receive at least one piece of the location information and the information analysis information on the multiple first devices or the multiple third devices compared with the multiple first devices.

13. The customer support system described in claim 5, wherein:
any one of the multiple first devices and the one or more second devices is further provided with a storage unit which stores at least one piece of information that the units in each of the multiple devices display, and information that is transmitted/received by the transmission/reception units, and
an information analysis information display unit which executes at least one of collection, analysis and calculation of each piece of information stored in the storage unit, as information analysis information;
the one or more second devices are each provided with a third device information display unit which stores, in the storage unit of the second device, at least one piece of use state/situation support information, deterioration/abnormality analysis support information, mending/repair support information, resale support information, buying company information, economy/environment/safety support information and new device purchase support information on multiple third devices compared with the multiple first devices,
acquires, from the one or more second devices via the network using the transmission/reception units of the multiple first devices,
and displays at least one piece of the use state/situation support information, deterioration/abnormality analysis support information, mending/repair support information, resale support information, buying company information, economy/environment/safety support information and new device purchase support information on multiple third devices compared with the multiple first devices, in each of the multiple first devices,
a display unit which displays at least one piece of information among information displayed on the units in each of the multiple first devices,
a control unit which controls at least one of the units in each of the multiple first devices,
a location information display unit which displays at least one piece of location information on the multiple first devices or the multiple third devices compared with the multiple first devices, and
second transmission/reception units which mutually transmit/receive, among the multiple first devices via a second network, each piece of information displayed on the units in each of the multiple first devices; and
the transmission/reception units in the multiple first devices and the one or more second devices further mutually transmit/receive at least one piece of the location information and the information analysis information on the multiple first devices or the multiple third devices compared with the multiple first devices.

14. The customer support system described in claim 5, wherein when the multiple first devices are vehicles, the economy/environment/safety support information display unit is further provided with
a drive start time detection unit which detects a vehicle drive start time (time of driving an engine or motor) of the vehicle, a drive stop time detection unit which detects a vehicle drive stop time of the vehicle,
a running distance measurement unit which starts, when the drive start time detection unit has detected the vehicle drive start time, measurement of a vehicle running distance accordingly after the detection, and stops, when the drive stop time detection unit has detected the vehicle drive stop time, the measurement of the vehicle running distance accordingly after the detection, then displays the measured vehicle running distance, and
a running energy measurement unit which measures a consumption of running energy consumed by the vehicle for funning the vehicle running distance that the running distance measurement unit has measured, wherein the economy/environment/safety support information display unit is further provided with an identification-attached vehicle running information display unit which attaches identification information to at least one of the vehicle drive start time, the vehicle drive stop time, the vehicle running distance and the running energy consumption, associates (links) two or more of said features with one another, to generate identification-attached vehicle running information, and stores the generated identification-attached vehicle running information in at least one storage units in the multiple first devices or the one or more second devices,
an average vehicle speed display unit which uses the vehicle drive start time, the vehicle drive stop time and the vehicle running distance, to calculate an average vehicle speed of the vehicle that has run the vehicle running distance, and an energy consumption cost display unit which uses the running energy consumption and the price of the drive energy per unit which has been acquired separately in advance, to calculate a consumption cost of energy that the vehicle has consumed to run the vehicle running distance.

15. The customer support system described in claim 6, wherein when the multiple first devices are vehicles, the economy/environment/safety support information display unit is further provided with
a drive start time detection unit which detects a vehicle drive start time (time of driving an engine or motor) of the vehicle, a drive stop time detection unit which detects a vehicle drive stop time of the vehicle,
a running distance measurement unit which starts, when the drive start time detection unit has detected the vehicle drive start time, measurement of a vehicle running distance accordingly after the detection, and stops, when the drive stop time detection unit has detected the vehicle drive stop time, the measurement of the vehicle running distance accordingly after the detection, then displays the measured vehicle running distance,
a running energy measurement unit which measures a consumption of running energy consumed by the vehicle for funning the vehicle running distance that the running distance measurement unit has measured, wherein
the economy/environment/safety support information display unit is further provided with an identification-attached vehicle running information display unit which attaches identification information to at least one of the vehicle drive start time, the vehicle drive stop time, the vehicle running distance and the running energy consumption, associates (links) two or more of said features with one another, to generate identification-attached vehicle running information, and stores the generated identification-attached vehicle running information in at least one storage unit in the multiple first devices or the one or more second devices,
an average vehicle speed display unit which uses the vehicle drive start time, the vehicle drive stop time and the vehicle running distance, to calculate an average vehicle speed of the vehicle that has run the vehicle running distance, and an energy consumption cost display unit which uses the running energy consumption and the price of the drive energy per unit which has been acquired separately in advance, to calculate a consumption cost of energy that the vehicle has consumed to run the vehicle running distance.
